(19) United States
(12) Patent Application Publication
(10) Pub. No.: US 2008/0026360 A1
(43) Pub. Date: Jan. 31, 2008

(54) Instructional Systems and Methods for Interactive Tutorials and Test-Preparation

(76) Inventor: David M. Hull, Chicago, IL (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/460,831

(22) Filed: Jul. 28, 2006

(51) Int. Cl. G09B 7/00

(52) U.S. Cl. 434/324

(57) ABSTRACT

Systems and methods which provide for learning, particularly learning in a professional school environment, that allow for interactive question and answer study sessions in the form of learning tutorials and test preparation modules which can be used in conjunction with traditional classroom learning techniques or other learning techniques and provide for improved interactivity and presentation compared to traditional systems.

### CROSS REFERENCE TO RELATED APPLICATION(S)

This application claims benefit of and priority to U.S. Provisional Patent Apps. Ser. No. 60/746,812, filed May 9, 2006, Ser. No. 60/715,089 filed Sep. 8, 2005; and Ser. No. 60/703,228 filed Jul. 28, 2005. The entire disclosure of all these documents is herein incorporated by reference.

### BACKGROUND

1. Field of the Invention

This disclosure relates to the field of education, particularly to computer assisted tutorial and test preparation materials.

2. Description of the Related Art

Education and the methodologies for providing education have changed recently as people become more interconnected and resources for student learning have become more interactive and more available. Learning has progressed from traditional teacher lecture models, to more interactive teacher student models, to distance learning whereby a user can be taught without having to be in the same location as the teacher. Further, these programs have also grown more interactive, incorporating audio and video recordings and even some interactive computer systems providing instant feedback to students.

While these systems represent a broad range of ways to provide for learning tools, they still suffer from a myriad of problems. Teacher-centric models, whereby a student is presented with information in lecture, whether in concurrent or remote location (such as by video), are often the standard of teaching. While the idea of a sage imparting wisdom is a longstanding concept, these types of systems provide for no or only modest interaction with students The traditional classroom instruction model is teacher-centric, i.e., it emphasizes the teacher's dominance and control of the learning process, but it leaves the student as a passive observer of the “sage-on-the-stage” teacher.

In professional schools, particularly law school, some teachers use the lecture method while others use the Socratic dialogue method, Socratic dialogue is a form of question and answer that involves intensive teacher-student interactivity. But that benefit of intensive interactivity is available only for a small handful of students, given the time constraints of a typical 50-minute class session, who are selected to participate that day. Therefore, students may have different involvement for different material depending on which day it is presented.

Teacher-centric teaching also generally provides visual support for the lecture, if any is provided at all, only in the form of an overhead transparency (or a PowerPoint™ facsimile) of bullet-point lists, block-and-arrow diagrams, or similar static notes. This practice lends little concreteness to an experience that, for the student, is often highly abstract.

Teacher-centric teaching also often provides for limited scoring and feedback, particularly in the professional school area where grades may be obtained only from a mid-term or final exam when it is too late for the student to improve learning, understanding and performance prior to grading. In the law school market, particularly, until a student receives his grade on the semester final exam, the student may receive little to no objective feedback regarding his progress in learning and understanding the course material.

In other contexts, such as, but not limited to, the graduate business school market, there are examinations and/or writing assignments due at the mid-term, which still leaves the student with only half of the semester to adjust his course and improve his academic performance.

Conventional distance learning, such as that provided by the Center for Computer-Assisted Legal Instruction (CALI), is built more upon a learner-centric model that emphasizes the student's control of the learning process instead of the teacher control as in the teacher-centric model. However, the CALI system still has significant problems.

A student can access the CALI distance learning courses before class (when and where he wishes, as they may be provided on the Internet), as a complement to the assigned reading, of after class, for review purposes. Similarly, the student using a CALI course encounters a carefully described fact pattern and sequence of questions for his review. The student can also revisit portions of the course as often as he needs to.

However, the CALI systems suffer from several serious limitations. The courses have no standardized look and feel. Some are also quite long, corresponding to much or all of the entire syllabus of an entire 14-week course. This often results in students simply entering answers toward the end of the period to allow them to move on instead of focusing on learning the material. This length can also make the CALI system somewhat difficult for a professor to integrate into his semester teaching plan. Other CALI systems are quite short, offering perhaps 15 minutes of interactive learning, thereby confusing the user as to the look and feel of the learning experience he can expect. Furthermore, the CALI courses seldom offer visual support for either the stated facts or the process of legal reasoning that they are teaching and reinforcing. This shortfall is problematic in general for the task of teaching abstract concepts and in particular for the task of teaching abstract legal concepts to students who, by the time they enter law school, may have experienced significant amounts of visual learning.

Still further, the CALI systems often are engineered with a high degree of navigational complexity, i.e., the direction of the user's path is determined according to the user's sequence of responses to the system's questions. This can represent an excessive level of interactivity to the extent that it complicates and lengthens the experience beyond the user's patience, and to the extent that it seeks to replicate the classroom experience beyond what professors would prefer from the system for their students' use.

The CALI systems also, while they can provide feedback to a user on a more frequent basis, seldom provide comparative feedback that allows a user to compare his performance against that of a peer group, or against response of various different grading levels so that he can evaluate his scoring in relation to others'.

The other common model for learning is the learn-by-doing model. The model is based upon the view that real learning must focus on a job-based task; place the user in a virtual environment that faithfully simulates the details of that task; give the user the chance to execute that task and to fail in the process, help the user navigate past that failure by supplying him with context-sensitive access to feedback from experts who have trodden that path and who nave relevant insights to share with the user; and encourage the user to press on, with no regard to mistakes.

This model has much to recommend and is familiar to law students who participate in various clinical studies. But in numerous academic markets, including (but not limited to the market for legal education), the learn-by-doing model has yet to be applied effectively in an online manner for the purpose of achieving three objectives—reinforce the transfer of content, develop legal reasoning skills and develop test-taking skills. The CALI systems target the first two of these three objectives, but are deficient for the reasons stated. The products that seek to help students prepare for exams, e.g, ExamPro and Examples and Explanations, are almost all paper-based and thereby provide none of the interactivity that, when properly designed, can enhance learning outcomes And the few that are digital offer little meaningful visual support for the learning process, provide interactivity that is limited to multiple-choice questions and answers, and fail to target the objective of developing test-taking skills.

### SUMMARY

Because of these and other problems in the art, described herein, among other things, are systems and methods to provide for learning, particularly learning in a professional school environment, that allow for interactive question and answer study sessions in the form of learning tutorials and test preparation modules which can be used in conjunction with traditional classroom learning techniques or other learning techniques and provide for improved interactivity and presentation compared to traditional systems.

Described herein, in an embodiment is a computer-readable memory storing computer-executable instructions for providing a computer assisted tutorial, the memory comprising computer-executable instructions for providing a hypothetical fact situation, the fact situation including both a first textual explanation and a first graphical image related to the first textual information; computer-executable instructions for presenting a question based on the hypothetical fact situation; computer-executable instructions for obtaining a response from a user of a computer, the response indicative of their answer to the question, computer-executable instructions for providing an indication the correctness of the answer, the indication including both a second textual explanation and a second graphical image related to the second textual information; computer-executable instructions for asking additional questions, obtaining additional responses, and providing additional indications of correctness; and computer-executable instructions for providing an essay style indication of outcome to the hypothetical fact situation after all the indications have been provided.

In an embodiment of the computer-readable memory the first graphical image may be a still image or a video image.

In an embodiment of the computer-readable memory the computer assisted tutorial is for a professional school course, such as, but not limited to law school courses

In an embodiment, of the computer-readable memory there is also included computer-executable instructions for providing a screen of Frequently Asked Questions (FAQ's)

In an embodiment of the computer-readable memory the hypothetical fact situation is representative of an essay question on an exam and the essay style indication of outcome comprises an excellent answer to the essay question.

There is also described herein, in an embodiment, a computer-readable memory storing computer-executable instructions for providing a computer assisted tutorial, the memory comprising: computer-executable instructions for providing a hypothetical fact situation, the fact situation including both a first textual explanation and a first graphical image related to the first textual information; computer-executable instructions for presenting a question based on the hypothetical fact situation; computer-executable instructions for obtaining a response from a user of a computer, the response indicative of their answer to the question; computer-executable instructions for providing an indication the correctness of the answer, the indication including both a second textual explanation and a second graphical image related to the second textual information; computer-executable instructions for asking additional questions, obtaining additional responses, and providing additional indications of correctness; and computer-executable instructions for providing an indication of the relative accuracy of the answers compared to a plurality of other users providing responses indicative of answers to the questions.

In an embodiment of the computer-readable memory the indication of relative accuracy is provided in graphical form and the plurality of other users may consist of others taking a class which is also being taken by the user, may comprise all users of the computer-readable memory, or may comprise any other group or combination of groups.

In an embodiment of the computer-readable memory the computer assisted tutorial is for a professional school course, such as, but not limited to law school courses.

There is also described herein, in an embodiment, a computer-readable memory storing computer-executable instructions for providing a computer assisted test preparation tutorial, the memory comprising computer-executable instructions for providing a test question in a graphical display format; computer-executable instructions for presenting a question based on how to prepare an answer the test question; computer-executable instructions for obtaining a response from a user of a computer, the response indicative of their answer to the question; computer-executable instructions for providing an indication the correctness of the answer; computer-executable instructions for indicating on the graphical display of the test question, indications of annotations related to the correct answer; and computer-executable instructions for presenting additional questions, obtaining additional responses, providing additional indications, and indicating additional annotations

In an embodiment, the memory further comprises: computer-executable instructions for presenting a question based on how to write an essay response to the test question; computer-executable instructions for obtaining a response from a user of a computer, the response indicative of their answer to the question; computer-executable instructions for providing an indication the correctness of the answer; computer-executable instructions for generating a textual indication of a written essay response by placing a correct answer into a textual template; and computer-executable instructions for presenting additional questions, obtaining additional responses, and adding additional responses to the textual template. The memory may also include computer executable instructions for displaying the textual indication of the written essay response in a format that can be compared to other textual indications of written essay responses which are comparatively less correct.

In an embodiment of the memory the comparison may compare the responses section by section or as a whole.

### BRIEF DESCRIPTION OF THE DRAWINGS

FIG. 1 Provides a general diagram overview of the system whereby tutorial products and test preparation products are sequenced according to a semester syllabus and potentially complement each other's use.

FIG. 2 provides an image, which may be used in the embodiment of FIG. 1, of the ‘home page’ of a tutorial, with illustrations of links to an Outline and to multiple Hypotheticals on which the lessons of the tutorial are based.

FIG. 3 illustrates the representative nature and scope of an Outline that corresponds to the content of a tutorial session in the embodiment of FIG. 1.

FIG. 4 provides an illustration of a statement of the rule on which the tutorial is based in the embodiment of FIG. 1.

FIG. 5 illustrates the introduction of the fact pattern of the hypothetical on which the multiple-choice questions will be based and the use of context-sensitive content, such as, but not limited to, Frequently Asked Questions (FAQ's).

FIG. 6 illustrates how the user iterates her way across a sequence of multiple-choice questions to arrive at the answer that correctly applies the rule to the facts.

FIG. 7 provides a diagram that illustrates the scoring of the user's performance on an absolute basis and relative to an anonymous, online peer group.

FIG. 8 provides a diagram of the sequencing of the test prep sessions and their potential to complement the use of tutorial sessions.

FIG. 9 illustrates the manner in which a test prep session begins, i.e., the presentation of an authentic law school examination.

FIG. 10 illustrates the manner in which, following the introduction [in FIG. 9] of the test question, the system begins a series of multiple-choice questions.

FIG. 11 illustrates the two-phase methodology according to which the essay answer will be developed.

FIG. 12 overviews the Active Reading process contained in the Planning and Organizing phase of the IRAC methodology.

FIG. 13 illustrates the Skimming step of the Active Reading process.

FIG. 14 illustrates multiple-choice question interaction in which the user learns the Scanning step of the Active Reading process.

FIG. 15 illustrates, in the context of Scanning, the manner in which the system provides a tutored response to incorrect answers.

FIG. 16 illustrates, in the context of Scanning, the manner in which the system responds with a tutored response to a correct answer.

FIG. 17 illustrates how, following the correct response, the system demonstrates a targeted skill, in this case the skill of scanning a conflict pairing to identify specific information that corresponds to the elements of the legal rule.

FIG. 18 illustrates the use of a multiple-choice question to introduce the Annotate step of the Active Reading process.

FIG. 19 illustrates how, following the correct response, the system demonstrates a targeted skill, in this case the skill of annotating a conflict pairing to anticipate the legal analysis.

FIG. 20 illustrates the result whereby, after successfully navigating a sequence of multiple-choice questions, the user has developed a Graphic Organizer, which visually (i) depicts the Key Events and Facts of the question; (ii) aligns the elements of the rule with the Key Facts, and (iii) creates an IRAC outline (Issue; Rule: Application; Conclusion), which will operate as a roadmap for writing an essay answer to the question.

FIG. 21 illustrates the use of a multiple-choice question to introduce the process of developing the essay answer, according to the IRAC model, using the Graphic Organizer as a roadmap.

FIG. 22 illustrates how, upon the user's selection of the correct answer to a multiple-choice question, the system responds with narrative text that confirms the rationale of the answer and, in the images at the top of the figure, depicts the step-by-step development of the essay answer.

FIG. 23 illustrates the final step of having developed an essay answer, following the IRAC model (as guided by the Graphic Organizer), for both issues that are implicated in the conflict pairing.

FIG. 24 illustrates the three types of formats—long-form comparisons; side-by-side comparisons; and a one-page summary comparison—whereby the system provides answers, graded from A to D, to the question.

FIG. 25 illustrates the long-form comparison of the A, B, C and D answers, each following the IRAC format.

FIG. 26 illustrates the side-by-side comparison of the answers according to the four components (Issue; Rule: Application; Conclusion) of the IRAC model.

FIG. 27 illustrates the one-page summary comparison of the four (“A,” “B,” “C,” and “D” answers.

FIG. 28 illustrates a login screen for a professor to utilize in setting up an embodiment of a tutorial.

FIG. 29 illustrates a screenshot of a general overview outline which can be used by a professor for navigation.

FIG. 30 illustrates a screenshot showing details of the overview outline.

FIG. 31 illustrates a screenshot for setting up a graphic organizer and test question for use in test preparation.

### DESCRIPTION OF THE PREFERRED EMBODIMENT(S)

Generally, the systems and methods discussed herein will be implemented using a computer, computer network, or other processor running software which implements instruction to the processor to provide displays as necessary to carry out the systems and methods. Software for providing the systems and methods to students may be provided on memory local or remote to a computer used by the student for the learning activity and may be provided to an individual student or may be provided to a number of students (such as entire class) using a computer network such as, but not limited to, the Internet, an internet, an extranet, or an intranet. In alternative embodiments, the instructions may be provided directly in hardware, or may be provided on software running remotely simply providing the student to access the material via a remote interface.

The Figures provide an overview of an embodiment of a system and method for providing computer assisted learning as it fits into the scheme of learning across the scope of a semester syllabus. This discussion and the associated figures show an embodiment of computer assisted systems and methods designed for use in a law school environment, and particularly for a first year contracts or criminal law class. These embodiments are in no way intended to limit the scope of the present invention, but instead provide for exemplary environments and embodiments. One of ordinary skill would understand how to adapt the systems and methods to other professional school environments or other education environments generally.

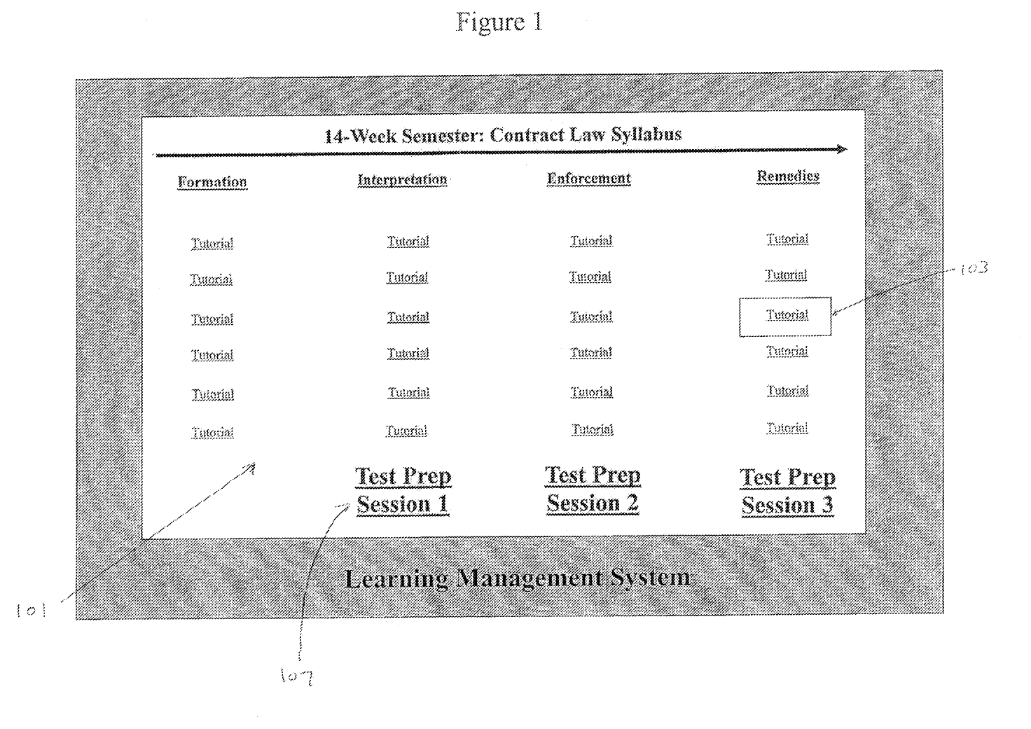

TUTORIALS—In the embodiment of FIG. 1, the systems and methods will generally be designed to provide for independent study after a student has completed assigned readings and prior to classroom (whether actual or virtual) presentation, or after the classroom presentation, or both. In the depicted embodiment, the user will first select a tutorial session that corresponds to that part of the semester syllabus on which the class is then focused. As shown in FIG. 1, the student selects from the array of tutorials (101) that focus on Remedies in a Contracts course. A tutorial (103) as indicated by the rectangle that focuses on a specific remedy, in this case the Cost of Completion, Diminution in Value remedy is selected. Upon selecting that tutorial (103), the user will generally log into or register with the system, using either a specific predetermined computer, such as, but not limited to a computer in the student's dorm room, or using the student's choice of a computer, with access regulated by a password or other identifier to ensure that the individual student's records can be accessed by that student only as understood by those of ordinary skill in the art.

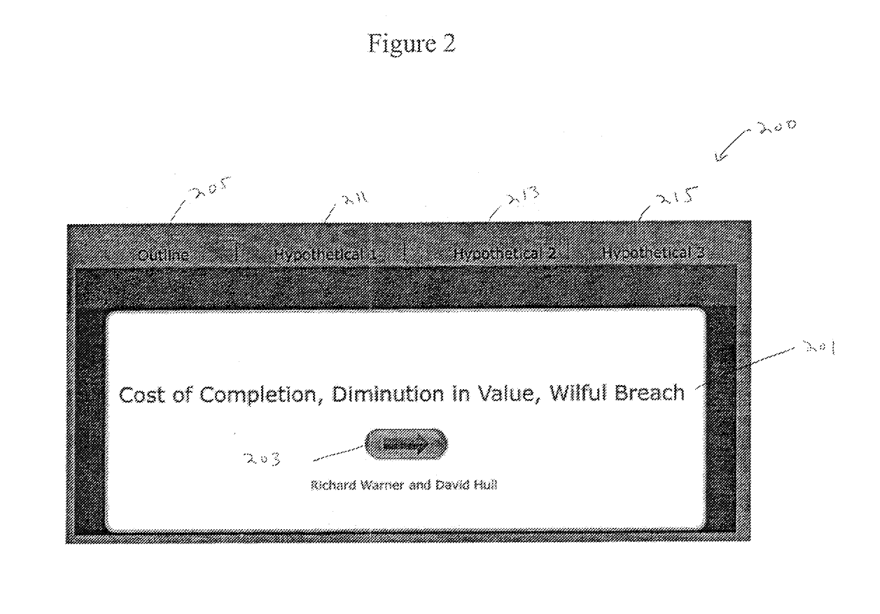

In this embodiment, once the tutorial is selected, the student will see a start screen (200) as shown in FIG. 2 which provides for the name of the tutorial (201) along with a ‘Start’ button (203) along with various navigation buttons for an outline (205), and three different hypotheticals associated with the particular tutorial (211), (213), and (215). This provided embodiment will be followed throughout this disclosure and the FIGS therefore simply present one exemplary system illustrating an example of presentation.

While not shown on the first screen of FIG. 2, there may also be buttons that link the student to the casebook that the professor has adopted for his course; if clicked, the student will be linked to that portion of the assigned readings that correspond to the system that the student is about to enter. The screen may also include a button that links the student to other study resources, e.g., an online legal research service, an online legal dictionary, an online hornbook, an online course outline, online access to semester exam questions (with accompanying model answers) that the professor has used in prior years, case briefings and similar study assistance materials.

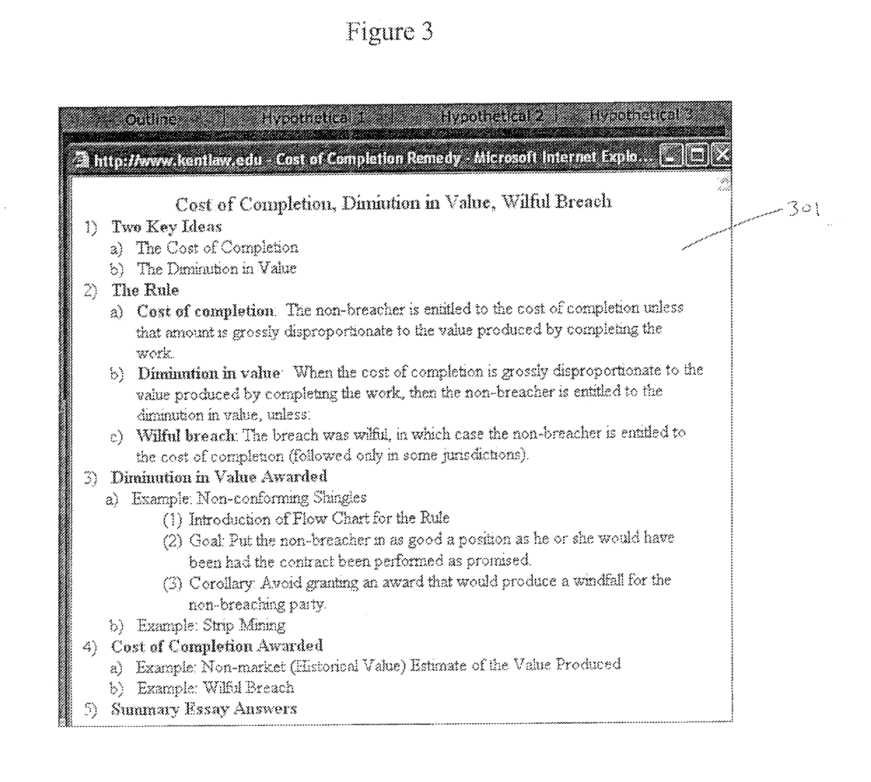

In an embodiment, the student could navigate to an outline (301) as shown in FIG. 3 that describes the sequence and scope of the content of the tutorial session by clicking the outline tab (205). Alternatively, this may simply be the point of starting when the star button (201) is pressed. This outline (301) may be shown on-screen and/or printed and may serve as a shell within which the student may add content from numerous other sources as she develops her customized semester study outline.

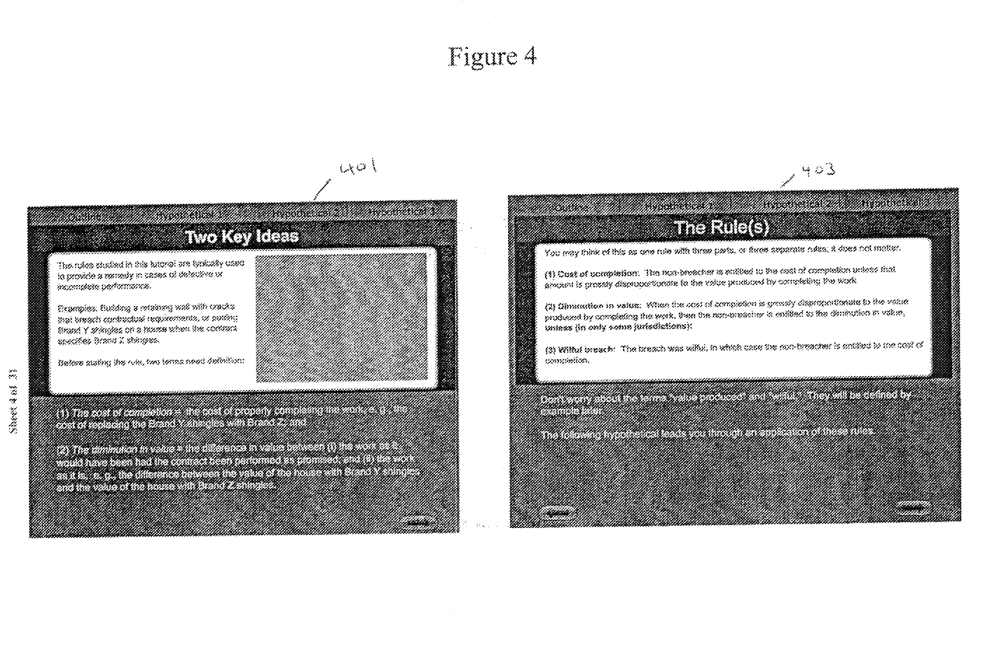

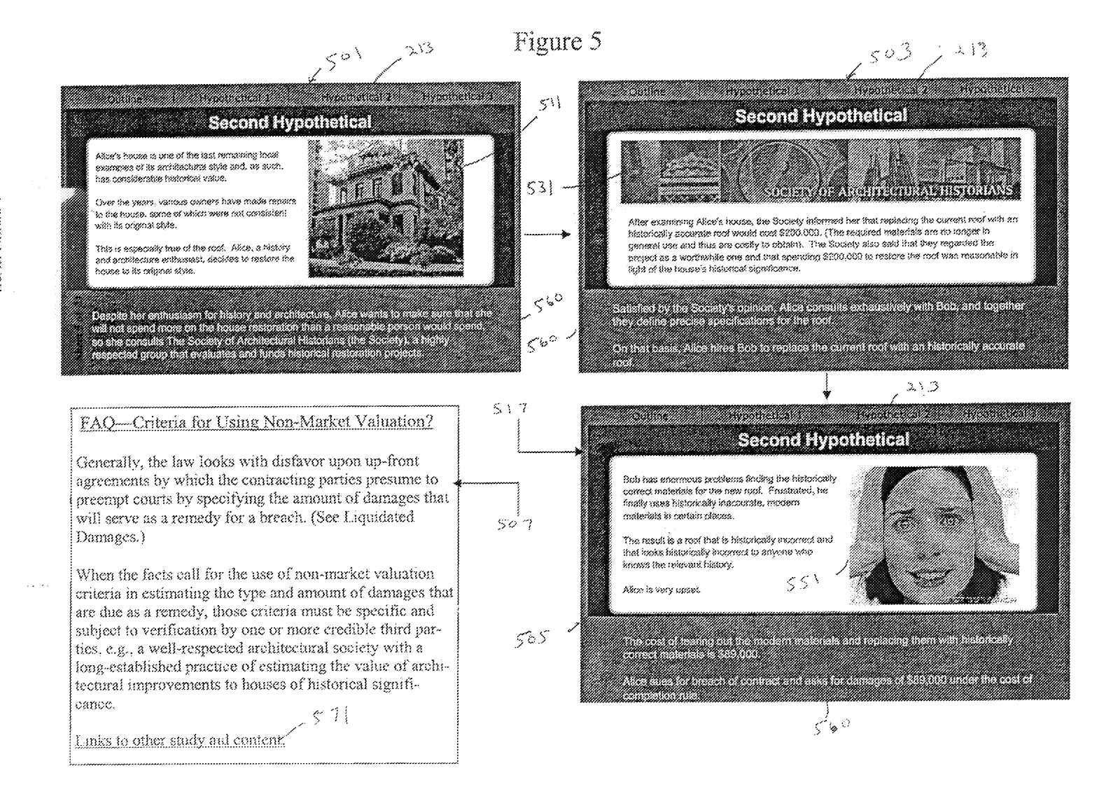

In an embodiment, the tutorial hypotheticals may begin with screenshots which provide a conceptual overview (401) and a statement of the rule of law to be investigated (403) as shown in FIG. 4 and over the course of the next several screens (501), (503), and (505) as illustrated in FIG. 5, a fact pattern of a hypothetical question is described in text and images. In this case the second hypothetical (accessed by clicking button (213) or as simply the second accessed in sequence is illustrated. In telling the story on which the tutorial is based, an embodiment of the system preferably uses visual components that are far more evocative that bullet-point lists or block-and-arrow diagrams. Thus, in FIG. 5, the systems uses a photo of (i) an historically significant house on which architecturally correct shingles (511) are to be installed, (ii) an image that evokes the standing of the third party whose valuation judgments form the basis for the use of non-market valuation criteria (531), (iii) and the owner's reaction to the contractor's having installed the wrong shingles (551). The images are provided in conjunction with text (560) explaining the fact situation.

These visual images may be still images (photos or graphic art) as indicated in this exemplarary embodiment, animations, streaming video (annotated or not with audio) and other forms of visual representation, such as, but not limited to, holograms (perhaps personalized to depict “public persons”) or other images that may become feasible as computers, broadband and related technologies become ubiquitous. The pictures may also be taken from real world examples based on actual case decisions or the like.

These images will generally make the telling of the story far more evocative and engaging to expanding majorities of students (in law school or elsewhere in professional schools of higher education) whose affinity for such use of technology explains much of the surge in Web-delivered news and the eclipse of newspapers.

The use of evocative images not only makes the telling of the story more eye-catching, it makes it more memorable and pedagogically effective. According to a deep body of academic research, the use of such images enhances the deep indexing of the story being told. It can be through the indexing of stories that we recall lessons and apply their principles to new fact patterns. It can also show practical application of the knowledge.

With each new screen that supports the telling and depiction of the fact pattern there is generally provided a set of Frequently Asked Questions (FAQ's) (507) which can be displayed to the user by accessing the FAQ button (517). Each set of FAQ's is preferably context-sensitive, that is, each set contains new content that pertains to the ongoing description of the fact pattern. An example of such FAQ content as it may appear in a screen image is shown in FIG. 5.

In an embodiment, these questions (507) may be tailored to suit the professor's thoughts for how the systems might be integrated into his teaching plan. By populating the FAQ's (507) with his choice of content, the professor can assure that his students, as they navigate the systems, are tracking his thought process; by accessing the context-sensitive FAQ's (507), his students can get answers to the questions that he knows the students are likely asking (or should be asking) at that particular stage of the system. Thus, the example of FIG. 5 illustrates that upon reading the facts of the hypothetical, the user may (or should) ask herself how the law goes about deciding the criteria by which non-market valuation criteria may be used in the determination of damages. In an embodiment, the user would click on the button labeled FAQ (517) to load this material to the screen. Doing so can then cause a pop-up window or similar display object to appear, in which the answer to the question is displayed. As further illustrated in the FAQ (507), the user may also have the option of clicking on one or more links (571) that would connect him to other sources of study content, e.g., excerpts from a hornbook, access to online case summaries and cases of recent vintage in which the rule of law regarding the use of non-market valuation criteria was recently tested or examined.

In this way, the systems and methods help the students better prepare for class, assured that they are on the teacher's “wavelength.” This gives the class and the professor the chance to begin class with a running start, with which the class could (a) more consistently reach more deeply into the professor's lesson plan for that day; (b) cover more material for that day; (c) engage in more ‘real-world’ exercises; or (d) examine more complicated or difficult fact patterns.

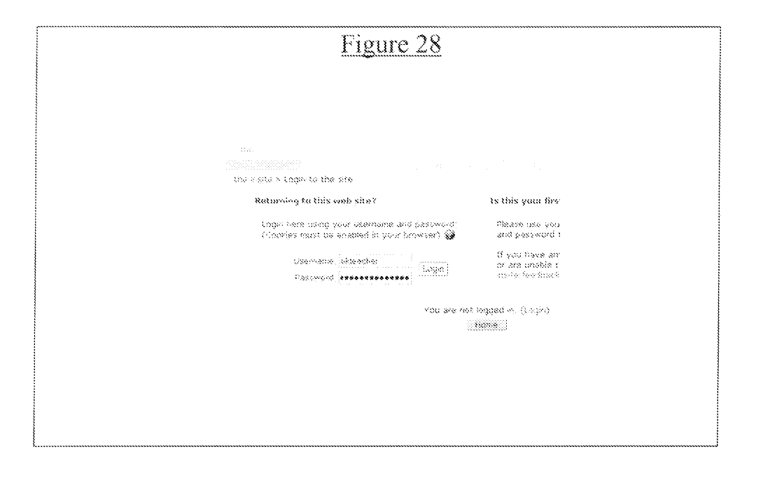

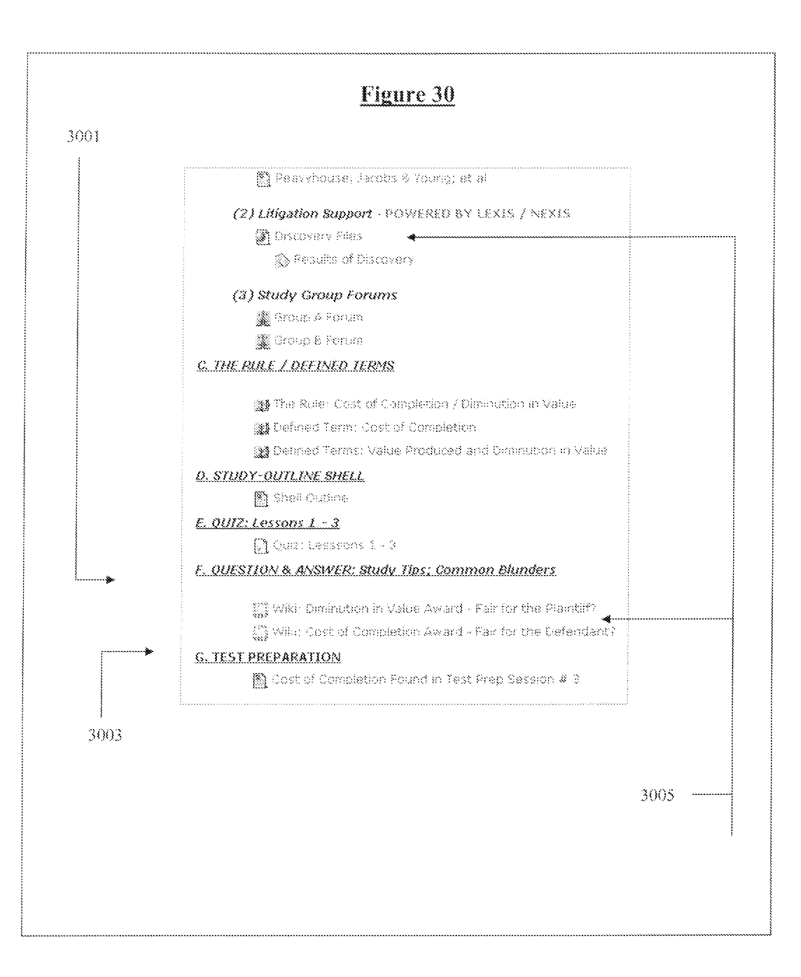

This ability to tailor the system, and to pinpoint that tailoring to the changing context within the system, represents an improvement over prior teaching materials, which tended to simply provide more traditional visual aids and were based on general principles. That the professor can update his tailoring within—or between—semesters, further enhances the distinctiveness of this improvement. The methodology for the professor to update the specific items being presented is discussed in more depth in conjunction with FIGS. 28-30.

Further, each system corresponds in whole or in part to readings of case law (or statute) that would be assigned to one or a small number of class sessions and would provide online links to such cases. This ‘component’ design enables the professor to more effectively target the system for integration into discrete portions of his teaching plan. The professor also has the latitude to adopt many—or few—systems, according to his view of their value (individually or collectively) as components of his semester teaching plan.

The systems preferably do not presume to teach didactically, such as by lecture notes and outlines. Such notes and outlines may conflict with those of the specific professors, and that mode of teaching strays from the mode of Socratic dialogue, whereby, in the upcoming classroom session, students will be expected to learn abstract legal principles by navigating fact-specific hypotheticals. Instead the materials allow for preparation geared to the expected classroom activity.

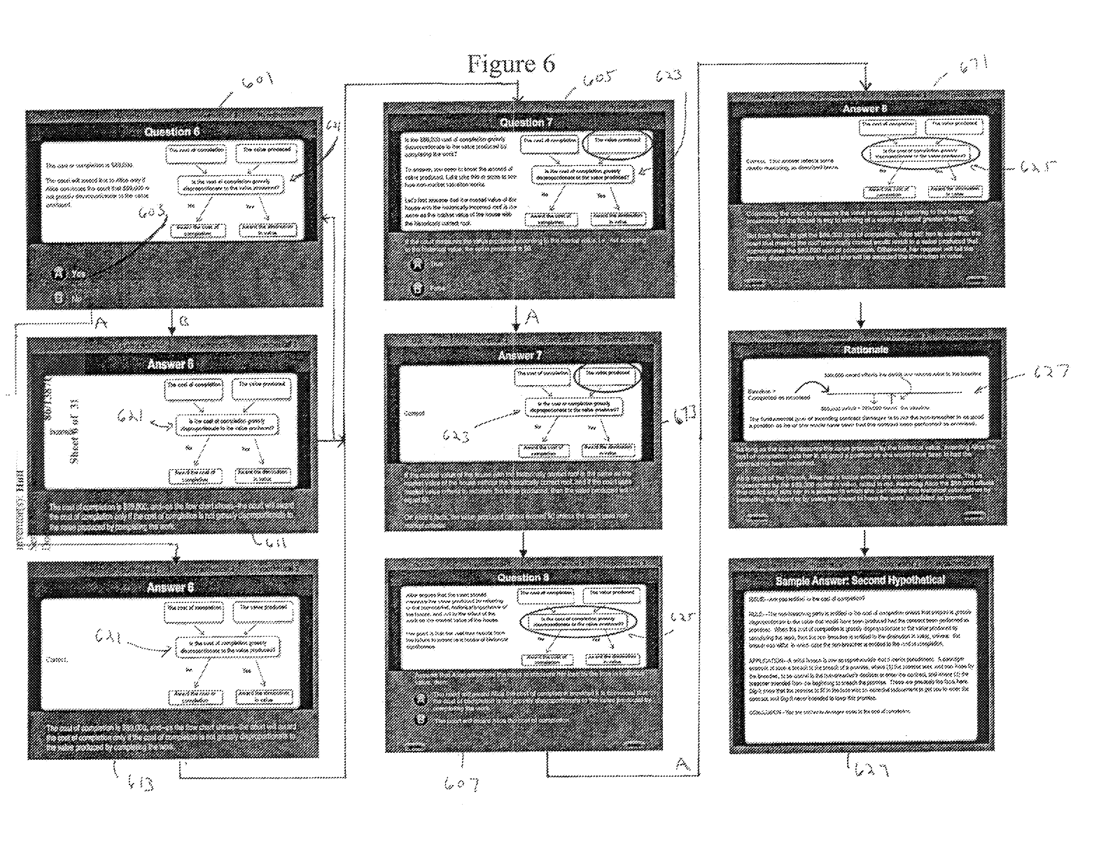

Once the fact pattern has been established as shown in FIG. 5, the system proceeds to FIG. 6 which presents a flowchart of possible screen images which provide the student with a series of questions and several alternative answers. The question (601) may take one of several forms, such as, but not limited to, multiple-choice, rank-order, fill-in-the-blank, typed response or any other. The mode of response may take one of several forms, e.g., a simple mouse-click selection or drag-and-drop. Or, envisioning future technologies, the mode of response may be oral or motion-detection or light detection, In the depicted embodiment, Question 6 is presented as a true false question when the user will click on a representation of an answer (603) to select their answer.

Upon receiving the student's response to the question (the first image of FIG. 6), the system evaluates the answer for its correctness and replies with a new screen (either Screen (611) or (613)). A correct-answer reply (613) will generally include the content that reinforces the rule and that is consistent with, and supported by, a supporting pedagogical image, as does an incorrect-answer reply (611). Thus, in Questions 6 through 8 (601), (605) and (607), the system uses a pedagogical image (621), (623), (625) here a flow chart, that requires the user to first identify the amounts of the ‘Cost of Completion’ and the “Diminution in Value.’ From there, and following the flow chart, the system requires the user to answer as Question 8 (607) whether the Cost of Completion is grossly disproportionate to the Diminution in Value. Upon ultimately arriving at the correct answer (671), the system then uses another pedagogical image (627) to explain the legal rationale whereby the amount of damages awarded achieves the goal of placing the non-breacher in as good a position as she would have been in but for the breach, but without providing a windfall to that non-breaching party.

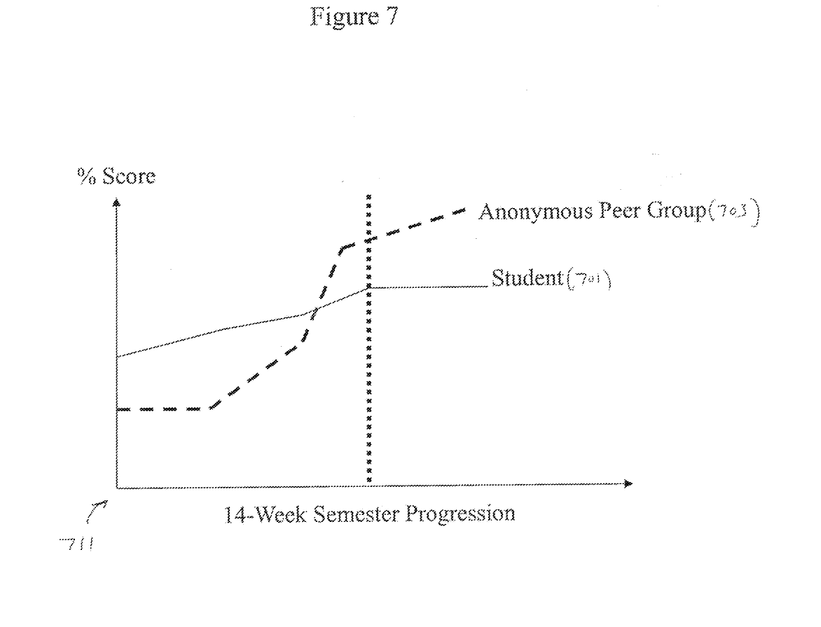

Concurrently, the student's results and answers to the various questions (601), (605) and (607) may be tracked for scoring and feedback purposes as discussed later in conjunction with FIG. 7.

The correct-answer reply will generally contain a button (or similar device) that the user can select to proceed in the system. Upon proceeding from a correct-answer reply (613), (673), or (671), the user will encounter the next question and answers in the system sequence and proceed in this manner until finishing the system for the particular topic, which may correspond to a reading assignment or classroom preparation.

The incorrect-answer reply (611) will generally also include content that reinforces the rule and that is consistent with, and supported by, the pedagogical image (flow chart) such as that in FIG. 6. This incorrect-answer reply, in an embodiment, is supported by the same access to FAQ's (507) and as was described in conjunction with FIG. 5 above. Upon reconsidering the question, the system will generally present the question again and the student tries again to answer it correctly.

Presenting the same question again once an indication of an answer being incorrect can provide an improvement over the prior practice of traditional distance learning. Traditionally, a student, instead of being allowed to answer the same question and solidify his understanding thereof, proceeds to a related question after an incorrect answer, which does not require the student to recognize the correct answer. The system can also provide information indicating why an answer is incorrect, but not providing any indication of what is incorrect with the incorrect answer. When returning to the question, it may then become apparent to the student what element or elements of the system they missed. In the event that they have a fairly thorough understanding but failed to pick up a single relevant point, they may only select a single incorrect answer, while if they have a major misunderstanding of the application of the material they may select multiple wrong answers for a number of different reasons and are provided with complete indications of their potential misunderstandings.

This type of presentation overcomes the presumption that the student gleaned enough from the incorrect-answer response to move ahead to another question. It instead allows the student of the opportunity to re-encounter and re-examine the same question, as he most often would in an interactive dialogue in class.

However, in some cases, the content provided by the incorrect-answer reply may be sufficiently complete and indicative in relation to the complexity of the question such that the student indicates sufficient knowledge to pass onto the next question.

The successive questions and answers may involve further probing of the issues that arise from the fact pattern. The architecture of that question and answer path may involve one or more vertical loops, that is, further exploration of the rationale and analysis that supports the correct answer to the first question. Alternatively, that architecture may be horizontal, that is, the path may proceed to other issues that remain to be spotted and accurately identified from the fact pattern.

In this manner, the systems and method creates for the student a new mode of Socratic dialogue. Previously, the student currently can only participate in class with the professor or observe such dialogue as an attentive listener. Now he can interact with Socratic dialogue outside of class. Further, the student can revisit portions of the Socratic dialogue as often as he needs to and every student can interact in a Socratic manner with the professor on every subject providing for much more opportunity for Socratic dialogue.

Each time that a question and its alternative answers are presented, the FAQ's (507) are preferably refreshed to provide the student with what are intended to be helpful perspectives, according to the professor's provision of tailored content. Each system may also be designed to be concise to provide for efficiency for students, who are often are pressed for time. And even when they are not, these Internet-savvy students have little patience for Web interactions that impose limitations on the user's time and choice.

In the final step of the depicted embodiment of a tutorial, the system reorganizes the legal analysis from the multiple-choice question into a form of essay answer (629). The purpose is to illustrate for the student how to apply the skills of legal reasoning with doctrinal language, as will be required for a semester final examination.

Upon finishing the tutorial (103), generally by finishing all the associated hypotheticals, the user may navigate similarly to the method discussed above to arrive at a screen displaying information such as that shown in FIG. 7. This information provides for a report that indicates his performance to-date (701) in use of the system relative to the performance of a peer group (703). In this embodiment, the information is shown as a time progression graph of percentage of correct answers (711). Most distance learning provides some form of scoring and feedback to the user. This provides interim feedback that is objective and that can be frequent But this feedback fails to compare the user's performance with the performance of comparable users. And most students, across academia, wish to know how they are progressing relative to their peers in class, in the school, or well beyond their school, this is insufficient.

The scoring and tracking of an embodiment of the systems and methods overcomes this limitation. As indicated in FIG. 7, the system may provide scoring and feedback to the student with every use of the system and progressing over time. Thus, in contrast to the current practice, the student who uses the system will get frequent and objective feedback on his performance.

Further as shown in FIG. 7, the systems and methods can provide comparative scoring versus a peer group both for a total of questions, and for each individual question. This allows them to compare themselves against the peer group on both total knowledge, and knowledge of particular subjects. In this embodiment, the student will also get an objective and frequently updated indication of how well his learning is progressing relative to that of others. And to students who are interested in comparative performance, e.g., class rank, this scoring and feedback will provide useful insights.

The systems and methods can also provide scoring and feedback to the student with every use of the system. Thus, in contrast to the current practice, the student who uses the system will get frequent and objective feedback on his performance in the system as well as updated indications of how well he his learning is progressing relative to that of others. And to students who are interested in comparative performance, e g., class rank, this scoring and feedback will provide useful insights. The peer group may be Web-based or may be a composite peer group.

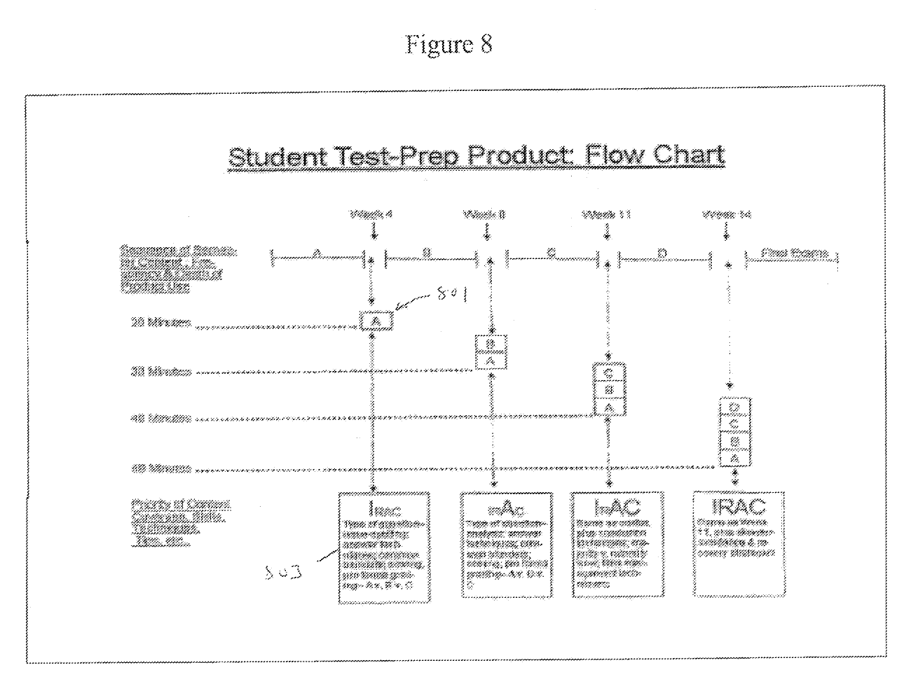

TEST PREPARATION—The above-described embodiment is generally designed to act as a study aid or teaching support to provide for benefits in classroom preparation or general knowledge acquisition/content transfer. The system may also or alternatively used to provide for specific test preparation, as now discussed specifically in conjunction with FIGS. 8 through 27.

A test preparation system would generally operate in a similar manner and an overview of how the systems and methods can be used for test preparation begins with FIG. 1. The user could select a test prep session (107) independent of the student's prior or future use of a tutorial (101) as shown. Alternatively, the student could select a test prep session (107) that generally follows the sequence of a block of tutorial sessions. In this manner, these embodiments can be used together in a complementary fashion that represents a law study system whereby the tutorial's primary focus on content transfer and legal reasoning is complemented by the test prep session's primary focus on the development of test-taking skills (and its secondary focus on content transfer and the development of legal reasoning skills). Again the user would log into the system and an introductory screen can identify the user, the name of the course, e.g., Criminal Law. Once again, the embodiment discussed is in the law school context, but one of ordinary skill would see how to adapt it to other academic environments.

The student clicks a ‘Start’ button to begin the session and thereby advances to the next screen. On that screen, the student views an interface that looks substantially like the image that appears in FIG. 2 as described above in conjunction with the class preparation model. The presentation may, however, be adapted specifically to test taking by providing the question in a form more typical to a law school exam such as in purely textual form. Further, the scenarios may have differences in length and issues. Some law school exam questions are brief, two or three blocks of text, while others are elaborate and require much more text. The extent to which the question that the student encounters is elaborate or lengthy may depend upon the scope and purpose of the session or the specific learning goal of the question.

As indicated in FIG. 8, the student's first session (801) will generally be scheduled at or about the four-week mark of the (14-week) semester. By this time, the professor will have covered content that is labeled ‘A’ and this content coverage will determine the scope of this first session. The purpose of the first session may be to focus on some first principles of taking a particular exam. In the law school context, this first session is to give the student instruction and practice in the skill of spotting issues (this represents the ‘I’ in the Issue Rule Analysis Conclusion (“IRAC”) model of the law school exam as indicated at (803) While such an organization whereby skills of test taking are provided in segments is preferred, there is no requirement that the questions be provided to focus on a particular area, or may be provided with the segments presented in different order depending on embodiment. This version is presented only as a single example. This session will preferably be designed to take about 45 minutes to complete.

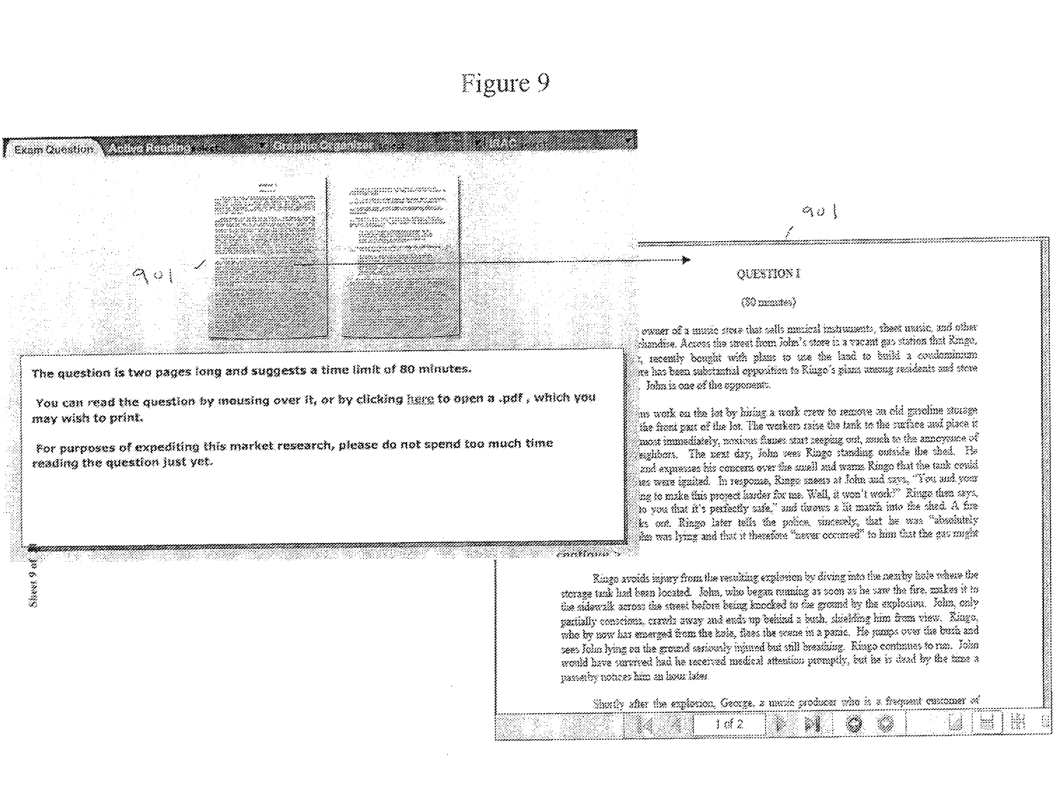

In developing the user's ability to spot issues in the fact pattern of a law school exam in this embodiment, the test-prep tool will focus on specific techniques for breaking down a complex fact pattern into sub-set fact pattern that isolates the facts of a conflict between a sub-set of the parties who are introduced in the complex fact pattern. Thus, to develop and practice these skills, the student will be presented with a block of text (901) as shown in FIG. 9 that calls for a broad, ‘issue-spotting’ survey of a fact pattern. (FIG. 9 illustrates the use of a printable .pdf document with which the user can explore in close detail the text of the question. Alternatively, the system may provide a ‘mouse-over’ feature for reading the text.) The student will be asked how best to go about organizing his answer to this question.

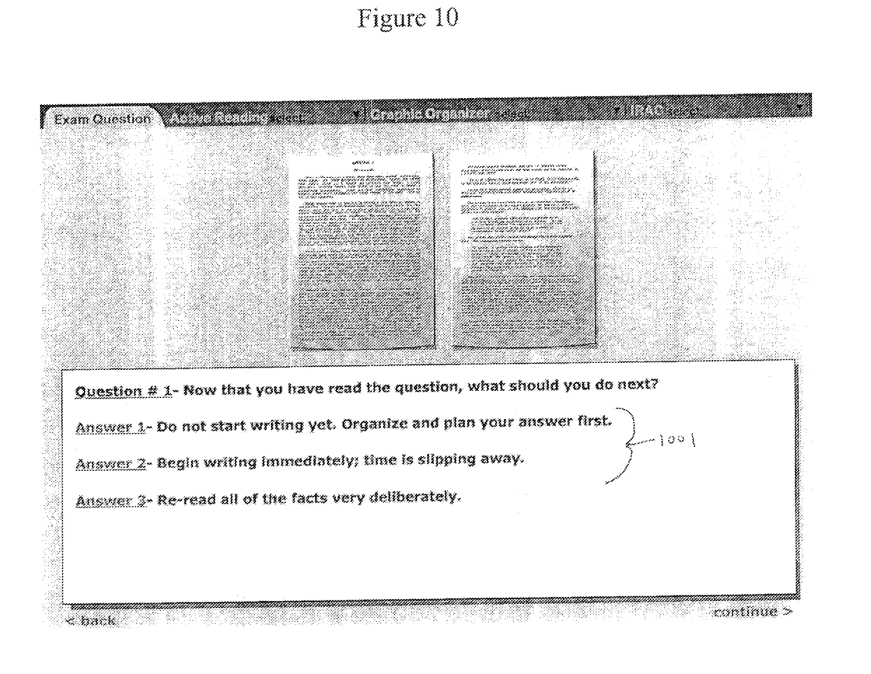

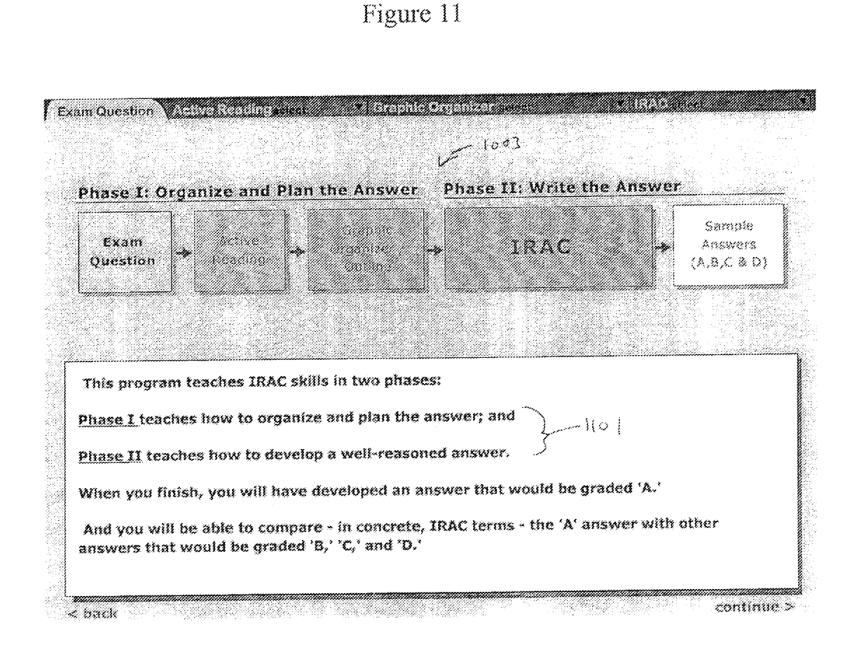

On the following screen, shown in FIG. 10, the student will be presented with several plausible alternative answers (1001), which, with the exception of the correct answer, represent common blunders that impair students' performance on law school essay examinations. The system proceeds in FIG. 11 to introduce a two-phase methodology shown both textually (1101) and in graphical form (1103) representing the methodology of answering the question—Phase I: Organize and Plan the Answer; and Phase II: Write the IRAC Essay—by which students can organize and plan, and then write, an effective answer to any law school essay examination.

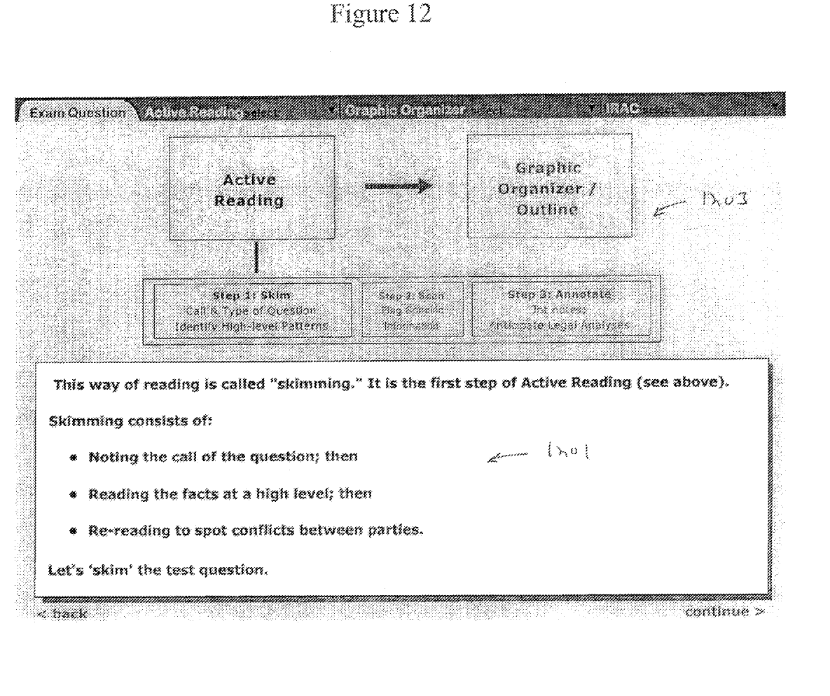

The iteration of correct-answer and incorrect-answer responses and their replies and sequences will generally parallel that described earlier for the interactive tutorial system. In the process described as Active Reading shown in FIG. 12, the student will learn how to Skim (for ‘conflict pairings’); Scan a conflict pairing to locate information (e.g,, verbs and utterances in a criminal law context) that implicates elements (actus reus and mens rea) of the rule of law; and Annotate conflict pairings with notations that anticipate legal reasoning analyses, with each step representing a strategy for interacting with the text. Again the methodology for “active reading” skills are shown both textually (1201) and in context graphically (1203).

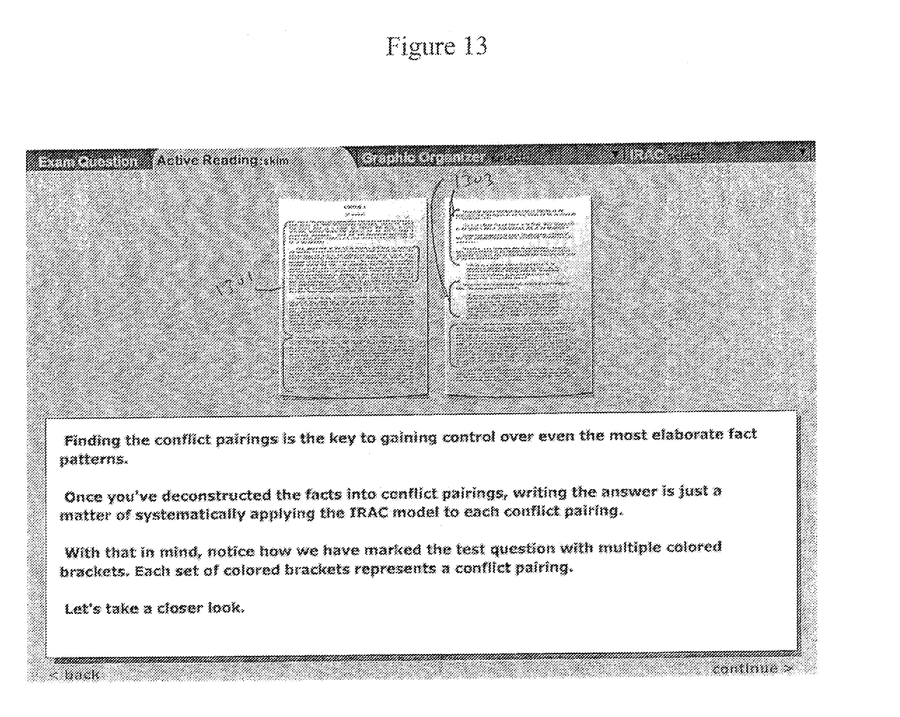

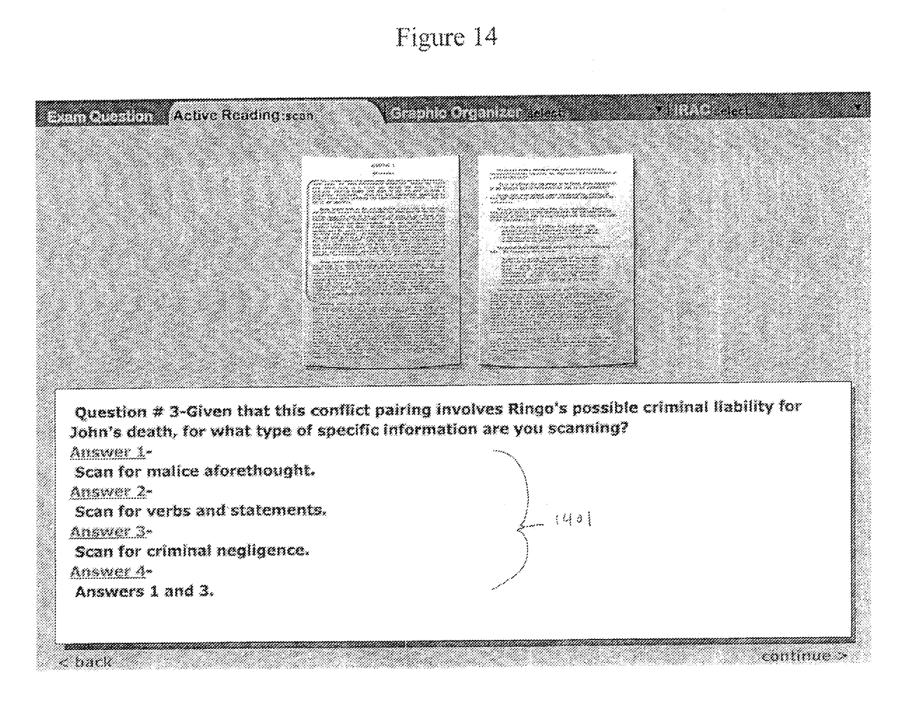

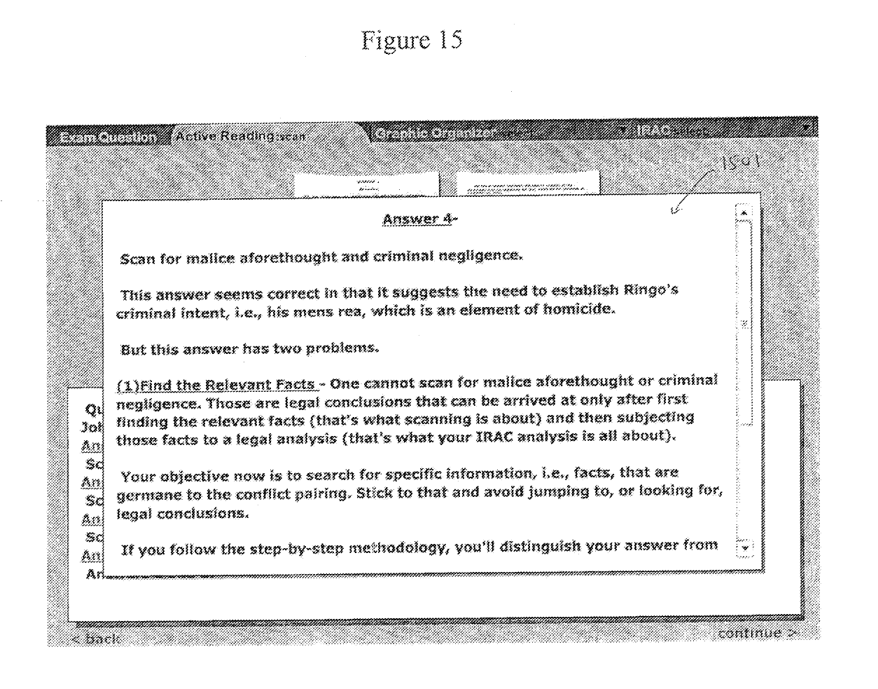

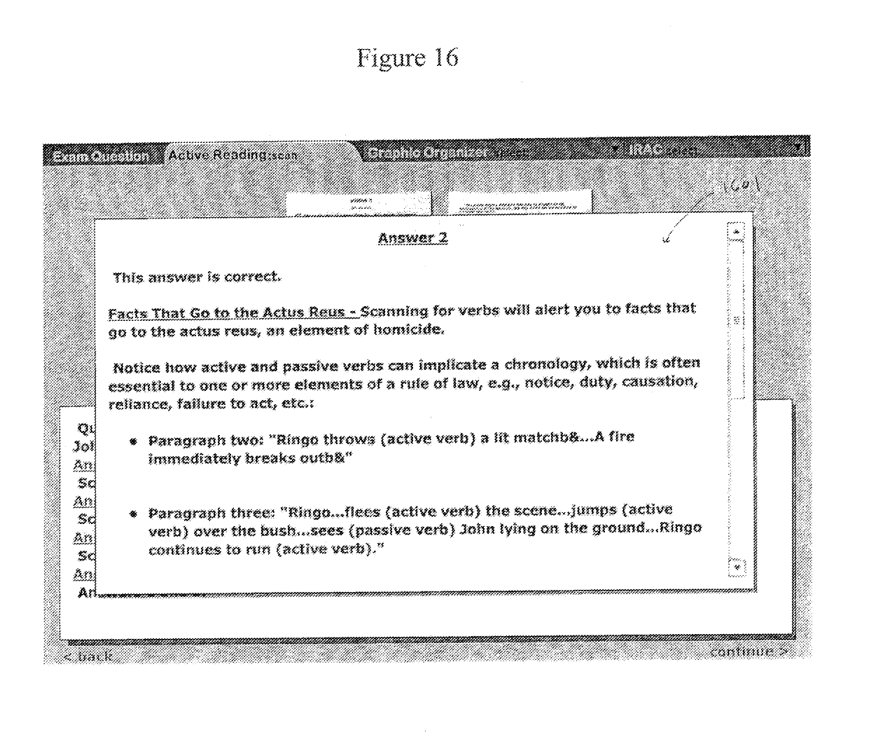

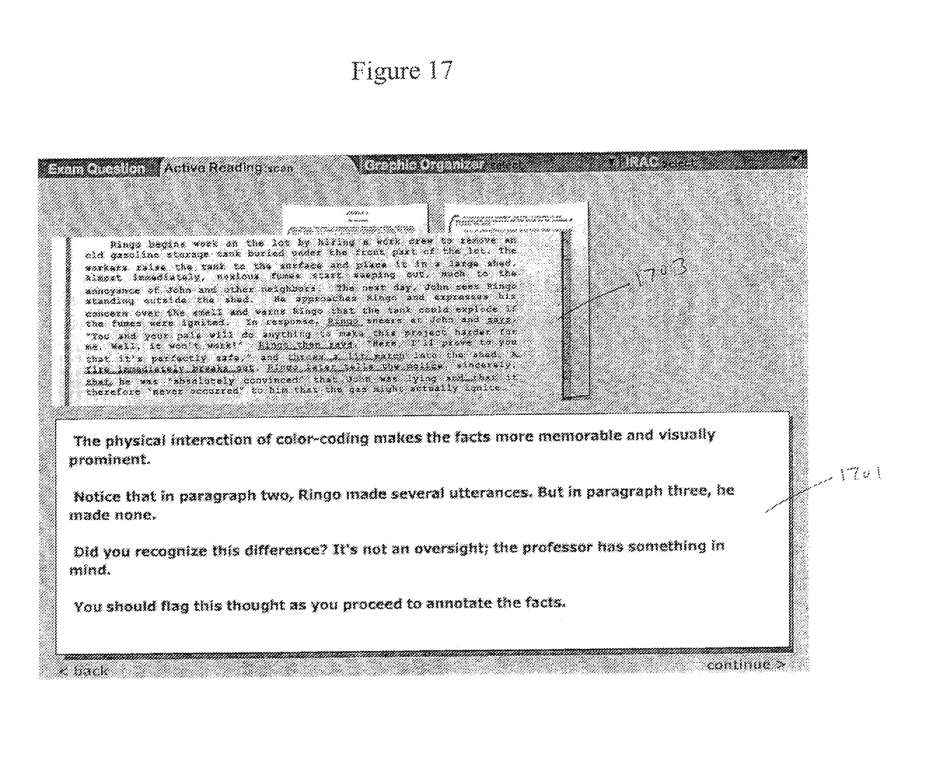

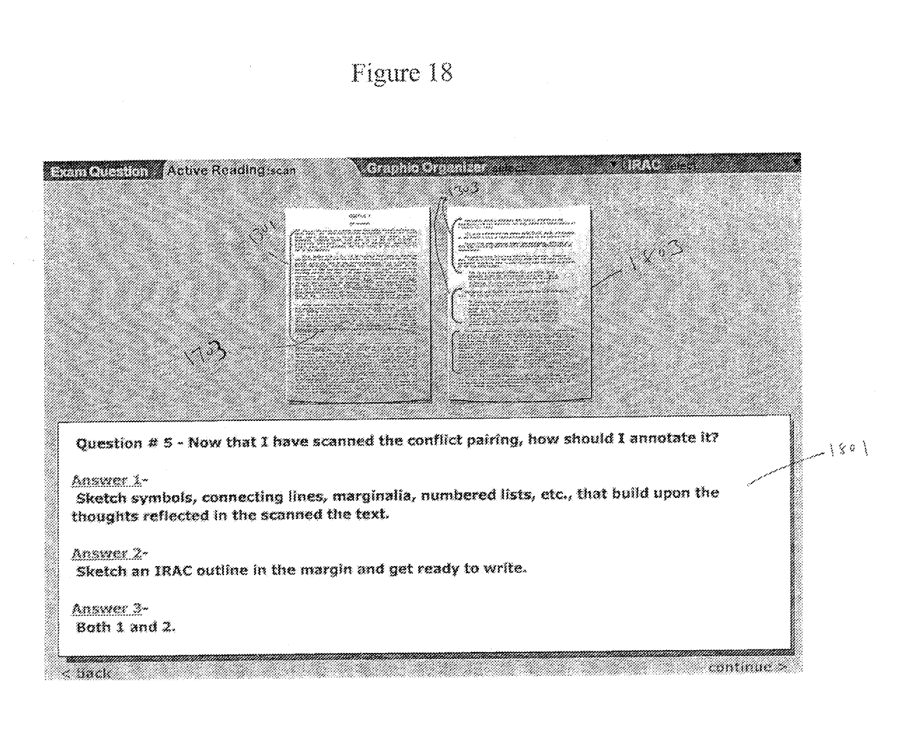

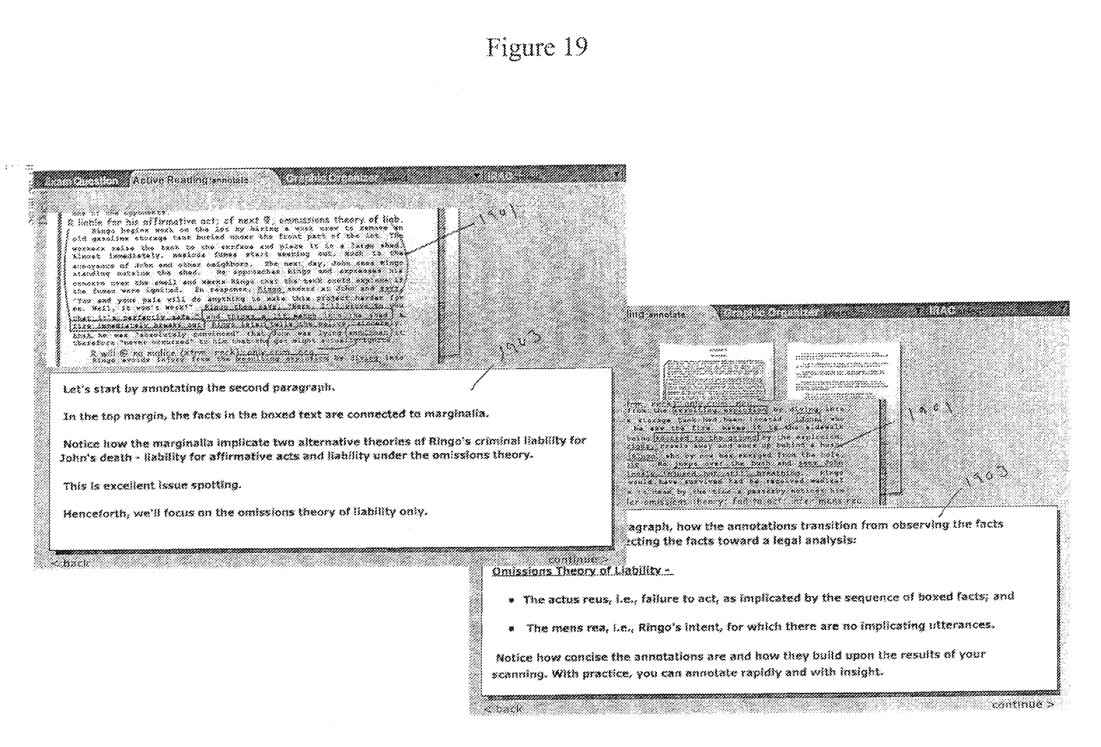

Thus, in FIG. 13, the system illustrates the results of having Skimmed the question to identify conflict pairings, i.e., related facts that coalesce where there are conflicts between parties—“conflict pairings.” The systems illustrates the technique of color-coding conflict pairings on the test itself, noting that some conflict pairings are contained in contiguous paragraphs (1301) and others are not (1303). The system proceeds to the next step of the Active Reading process—Scanning In FIG. 14, the user is asked how to skim the question and is given four plausible responses (1401). In FIG. 15, the system responds to an incorrect answer, explaining why that answer is deficient (1501) and suggesting that the user try again to find the correct answer. In doing so, and in explaining the rationale for the correct answer (1601) as shown see FIG. 16, the system reinforces (i) the test-taking skill of scanning, (ii) the legal reasoning skill of distinguishing between facts and conclusions; and (iii) the transfer of knowledge/content, e.g., confirming that mens rea is an element of the rule. In this way, the system demonstrates its method of helping the user prepare for tests not by didactic and abstract instruction, but by using an authentic test question, with facts and issues that are specific to a particular law school course. Upon iterating his way to the correct answer, the system responds (1701), in FIG. 17, by illustrating how to identify verbs and utterances that implicate the mens rea and the actus reus issues including physically showing the annotation on the problem (1703). Last, the system proceeds to the final step of Active Reading—Annotating. In FIG. 18, the system presents another multiple-choice question (1801), requiring the user to exercise the test-taking skill of annotating and, within that, the legal reasoning skills whereby the user begins to link the facts to the rule. It should also be clear that the various indications (1301), (1303) and (1703) are maintained on the visual image of the question (1803). Thus, once the user has iterated his way to the correct answer, the system illustrates, in FIG. 19, how to annotate the conflict pairing (1901) and describes how to do such illustration (1903).

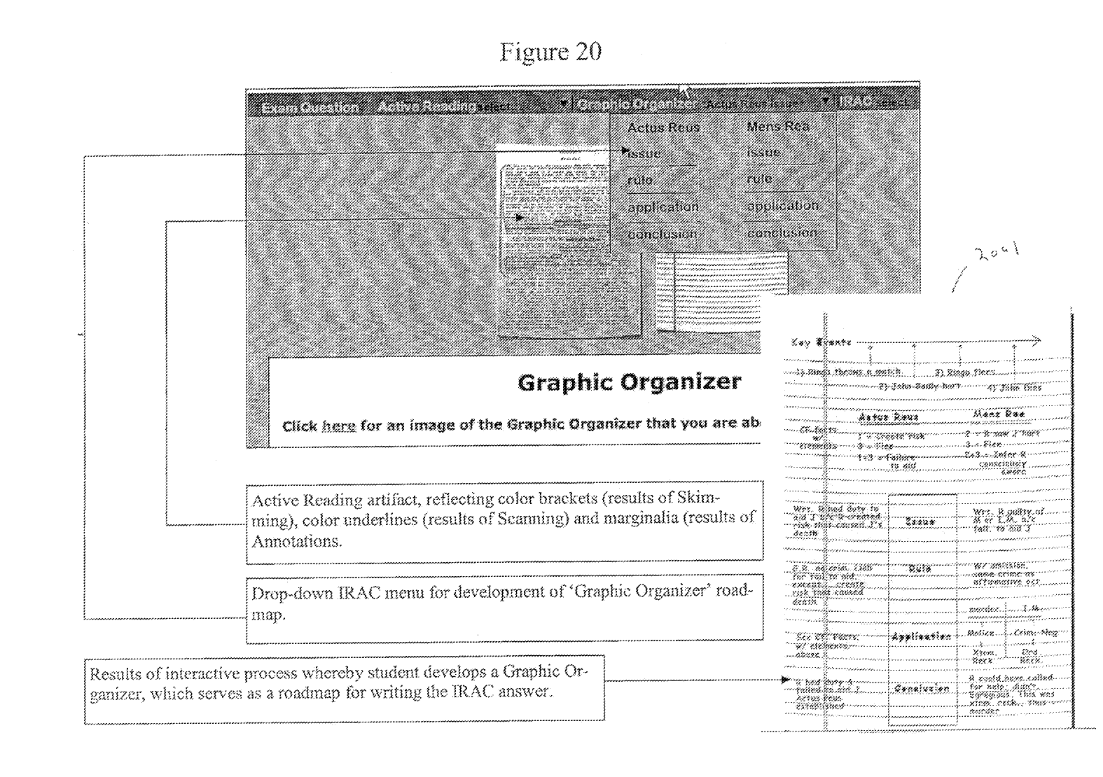

Thereafter, student will build upon the insights gained from the Active Reading process to develop a Graphic Organizer (2001), i.e., a visual tool or roadmap with which to envision the essential facts of the question, align the facts with the elements of the rule of law, and organize a persuasive answer that concisely and persuasively interweaves the facts and the rule into an essay that uses doctrinal language as shown in FIG. 20. The process of developing this Graphic Organizer continues the pattern whereby the user iterates his way to correct answers to multiple-choice questions. The result is the development, in FIG. 20, of the Graphic Organizer (2001). This image addresses the two issues (mens rea and actus reus) that were identified in the Active Reading process of the prior FIGS. For each issue (mens rea on the left side; actus reus on the right side), it provides a visually evocative summary IRAC outline (Issue; Rule; Application; Conclusion) that anticipates the writing of the essay answer.

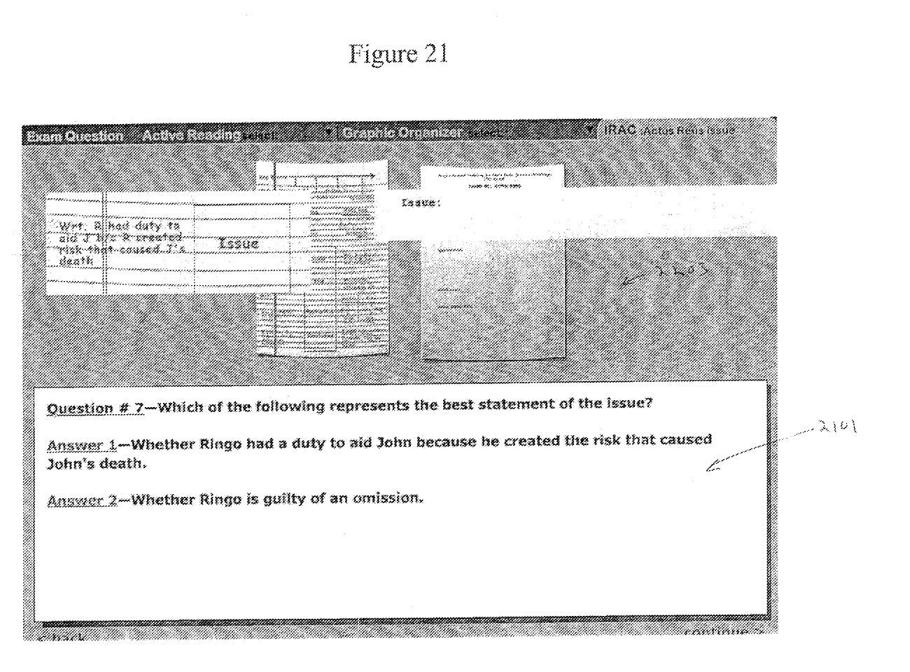

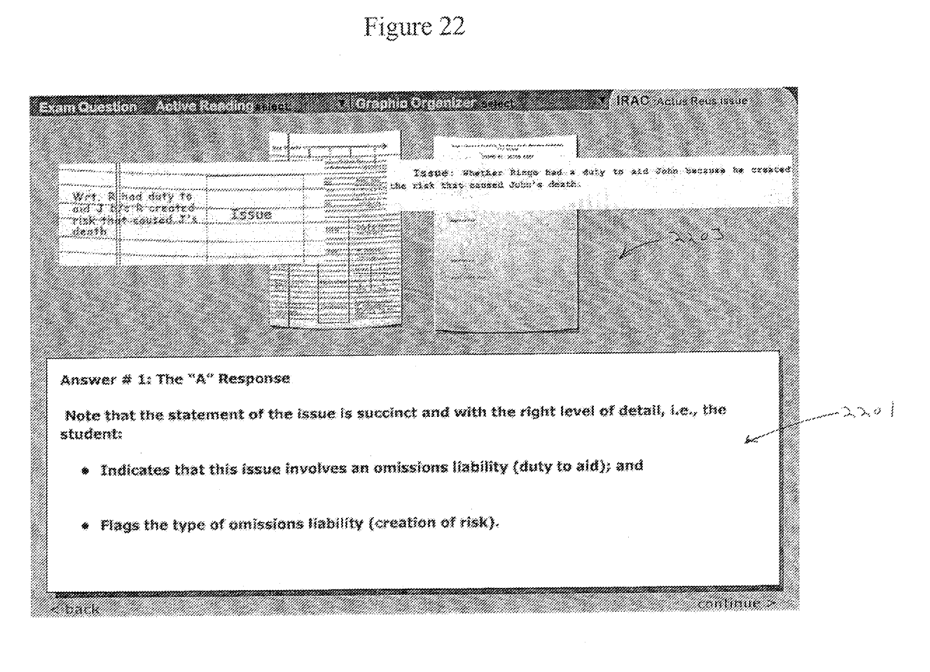

Continuing, the student uses the Graphic Organizer (2001) as a roadmap to develop an IRAC answer for each legal issue that is implicated in the conflict pairings as indicated in FIG. 21. In doing so, the student answers numerous multiple-choice questions (2101) pertaining to each component of the IRAC model. The multitude of answers to those questions provides the student an indication of the different scales of quality of law school essay answers as indicated in FIG. 22. For instance, the answers may all be correct, but may correspond to an answer of different grading levels. For instance, a wandering complete answer may be considered a “B” answer, while a concise answer may be considered an “A” answer and an answer missing a major issue, but having several off topic discussions may be a “C” answer. In this way the student may learn to grasp presentation and issues related to the response as well as the importance of staying on the issues requested by the question. Thus, in FIG. 21, the user is asked (following the IRAC model) to select the best statement of the Issue (2101). The system responds to the correct answer by confirming the rationale, as illustrated in the narrative text box (2201) at the bottom of FIG. 22. The system also begins to fill in the essay answer, as indicated in the image of an answer (2203) at the top of FIGS. 21 and 22.

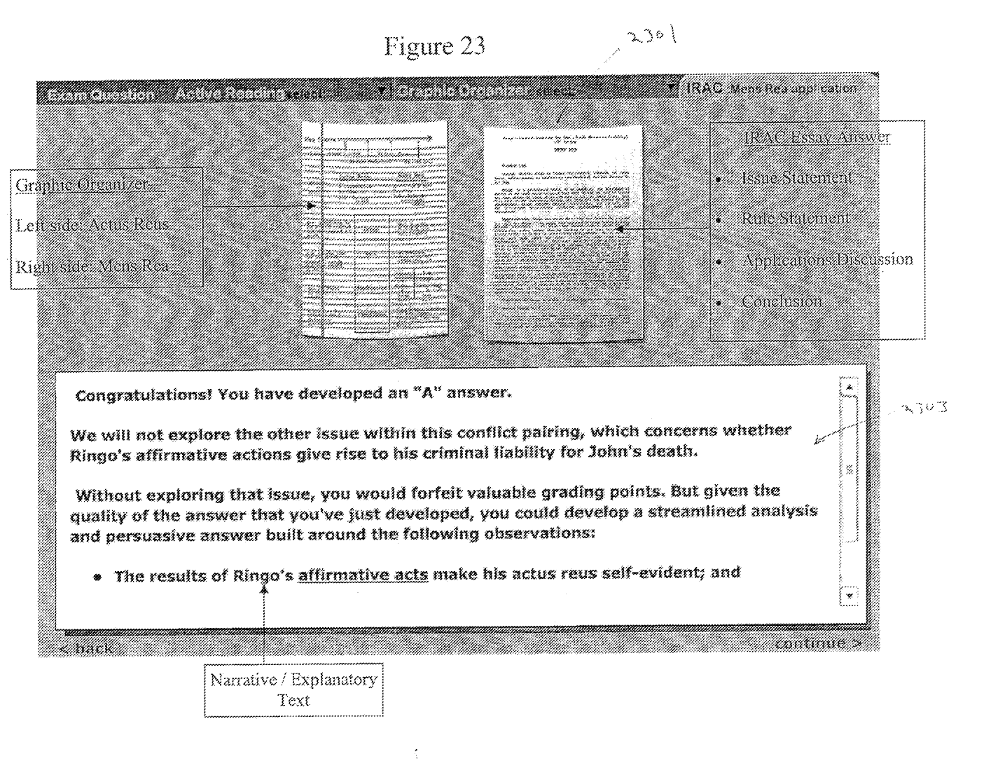

Following this sequence of multiple-choice questions and answers, the system requires the user to develop an essay answer for the first issue (actus reus), following the IRAC model, and then for the second issue (mens rea). At each step, the system explains the rationale for the correct answer, which corresponds to a letter grade of “A.” The system generally also explains why the other answers to each question fall short of the “A” answer as discussed later. In each case, the system visually depicts the step-by-step completion of the essay answer. As illustrated by FIG. 23, in the end the user has completed the IRAC essay answer for the mens rea issue illustrated by the completed answer (2301) and related text (2303).

Continuing with this embodiment, the student would generally conduct another session after approximately eight weeks have passed as shown in FIGS. 1 and 8. In this case and the following two sessions, the content coverage is cumulative, with the order of emphasis placed on the content most recently covered. The duration of the learning episodes may build over the course of the semester (as indicated in FIG. 1), although in some cases, the duration may follow a different pattern. And although the IRAC skills on which the session focuses will vary, the student will have practiced each skill by the end of the final session.

The content can again be custom selected and written by the Professor to ensure student focus on aspects he personally thinks are important to have learned. Feedback may also be again provided to the student in both peer group and individual question analysis to allow for more detailed understanding of the students relative performance. Each session can again also be annotated by context-sensitive FAQ's that represent the cumulative insights and wisdom of editors who have designed and graded many exams in the particular subject matter on which this particular test-prep tool focuses.

The system, therefore, can provide much more specific question and answer capability to generic test preparation materials as are common. Further, the ability to provide sub response answers and various levels of answers instead of simply model answers (which generally only show ideal or “A” grading level answers) allows a student to focus in on the differences between their selected answer and an ideal answer, or a worse answer, and can provide a level of comfort of knowledge of material and of required test taking techniques which can serve to lower anxiety levels and also improve test performance. Further, as questions can be presented in a form provided by the professor, the student will often have more of an idea of what type of questions to expect on the exam, as well as the type of answers expected by the professor.

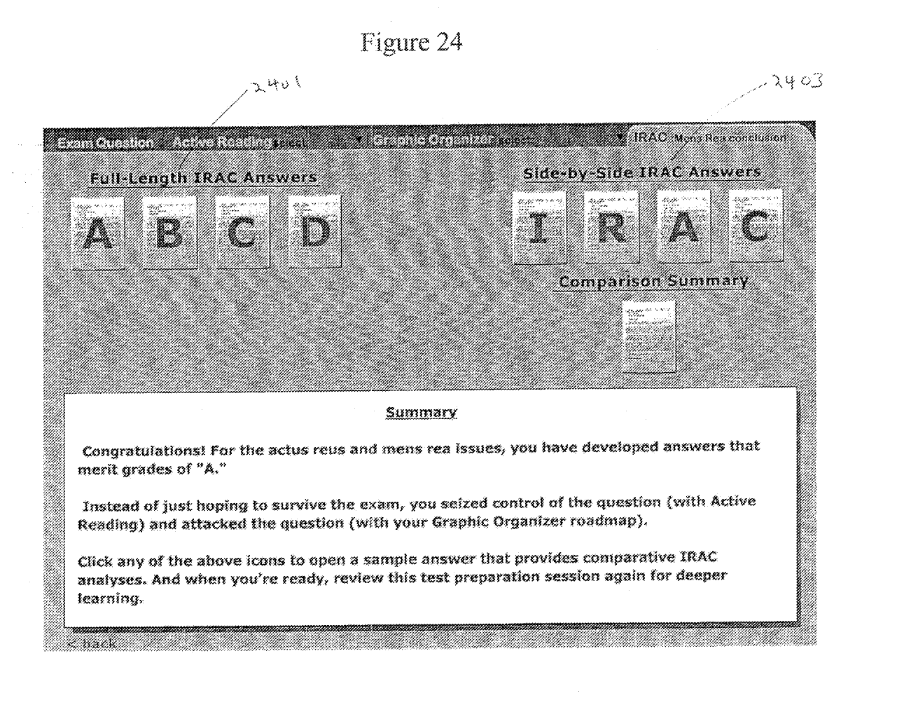

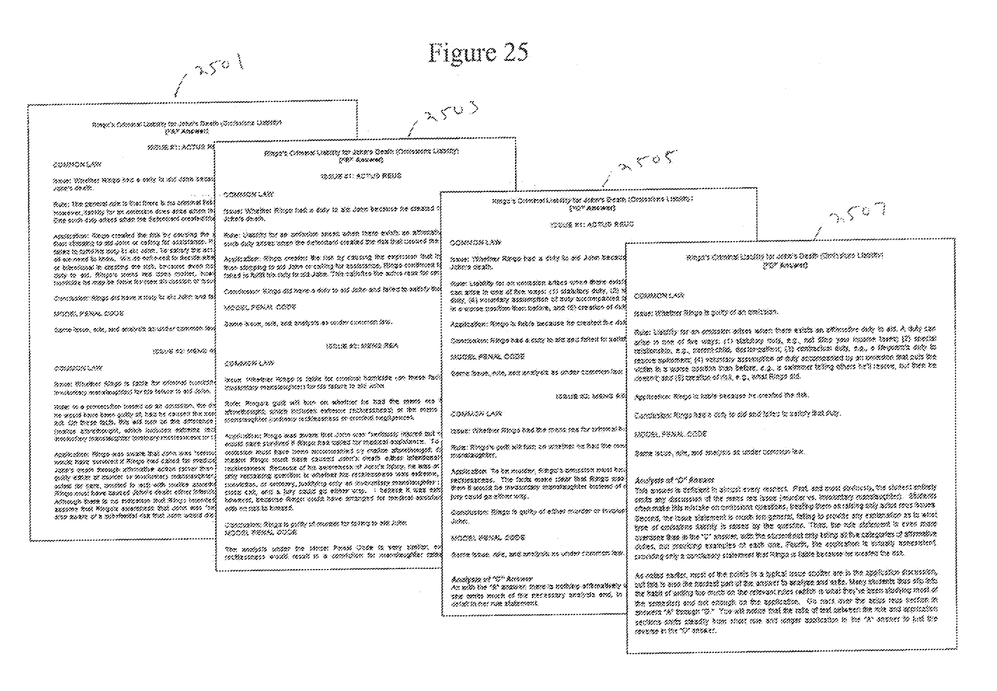

As a conclusion to a Test Prep session, the student may be given access in FIG. 24 to the final IRAC answers in three formats. The long-form format (2401) once selected is shown in FIG. 25 provides a complete IRAC essay for an answer that would be graded “A” (2501) and another essay for an answer that would be graded “B” (2503) and so on for essays graded “C” (2505) and “D” (2507) These answers would each provide the prose of the answer and a comparative analysis of the quality of the answer.

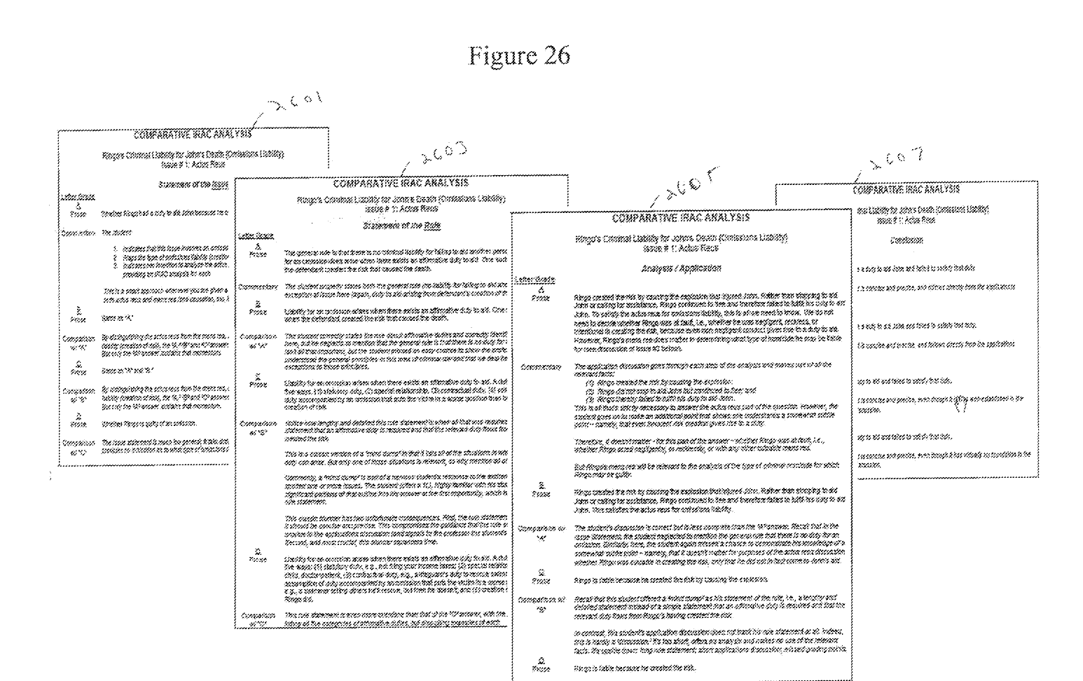

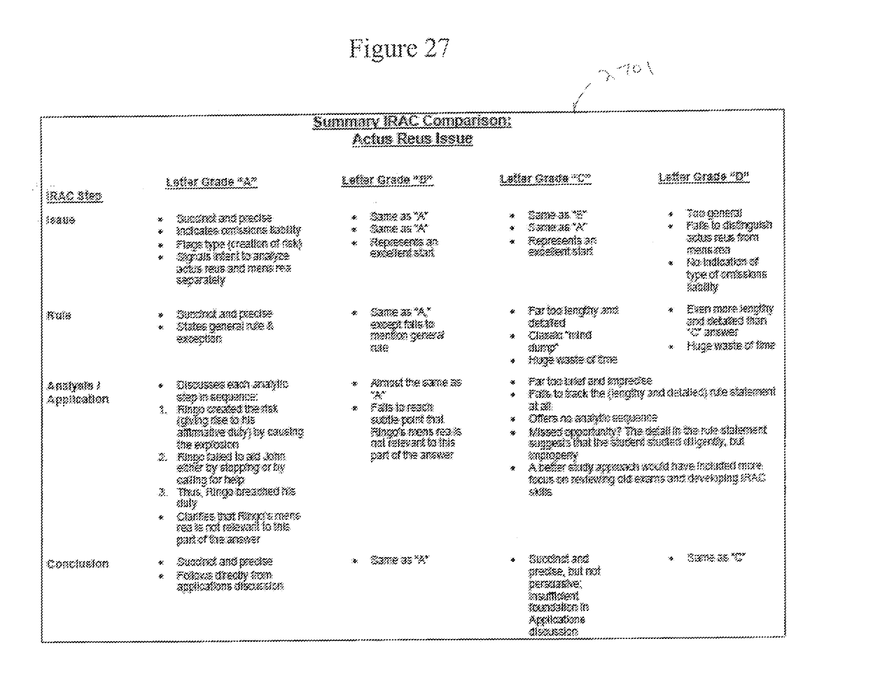

The side-by-side format selected by link (2403) is alternatively shown in FIG. 26 and provides comparative analyses of the A through D answers at the level of the Issue Statement (2601); the A through D answers at the level of the Rule Statement (2603); the A through D answers at the level of the Application discussion (2605), and the A through D answers a the level of the Conclusion (2607), The one-page format (2701) of FIG. 27 provides a one-page comparative summary analysis of each IRAC component of FIG. 26 in an easier to read format.

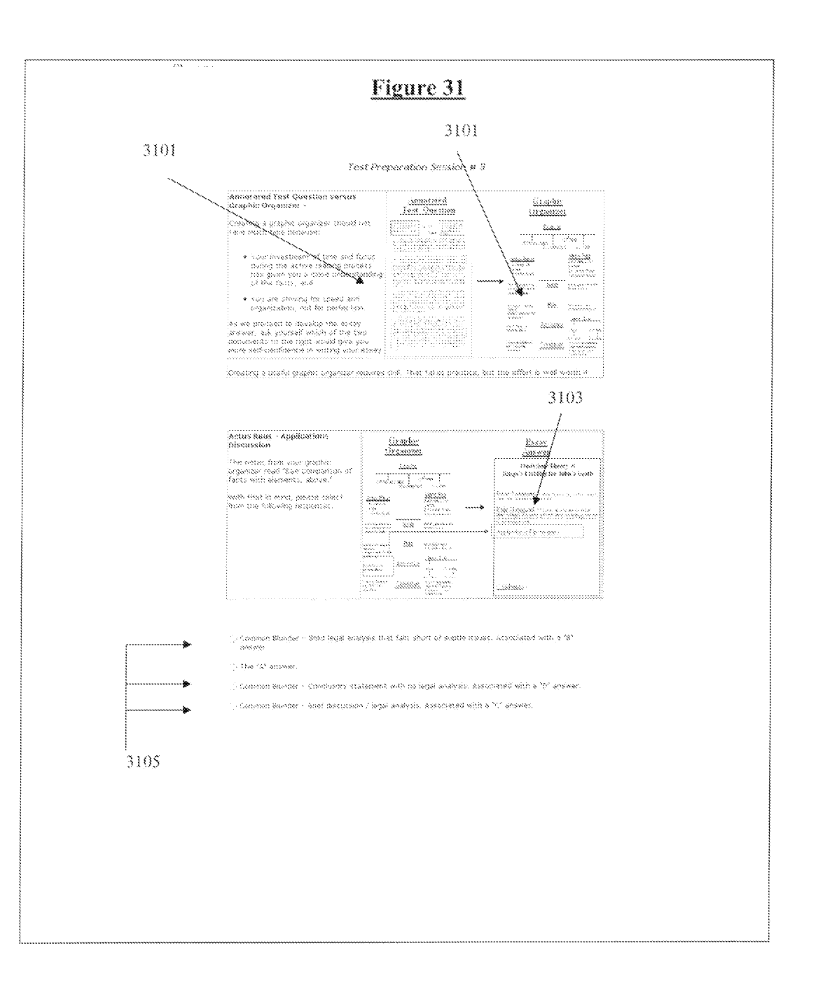

Taken as a whole, the foregoing reflects and embodies principles of ‘precision learning’ whereby professors can tailor the system for tactical intervention within students' studies and students can personalize their use of the system to make their studies more engaging and effective. This, the schematics in FIGS. 28 through 31 illustrate how a professor or other educator, in an embodiment, could log in to the system (FIG. 28), select a session (of a tutorial or a test preparation session), e.g., the Cost of Completion Remedy; within the lesson, use a hierarchical outline to navigate to a particular learning object, e.g., Lesson 1; and within that object, navigate through an instructional path represented by text and supportive images, with access to context-sensitive content, e g., “FYI,” which flags concepts that are related to the concept at hand; “Common Blunders,” which flags common mistakes in reasoning or knowledge that have caused students to under perform; and “My Notes,” which allows the student to capture thoughts, reminders and notes and index them to her password-protected semester study outline (FIG. 3).

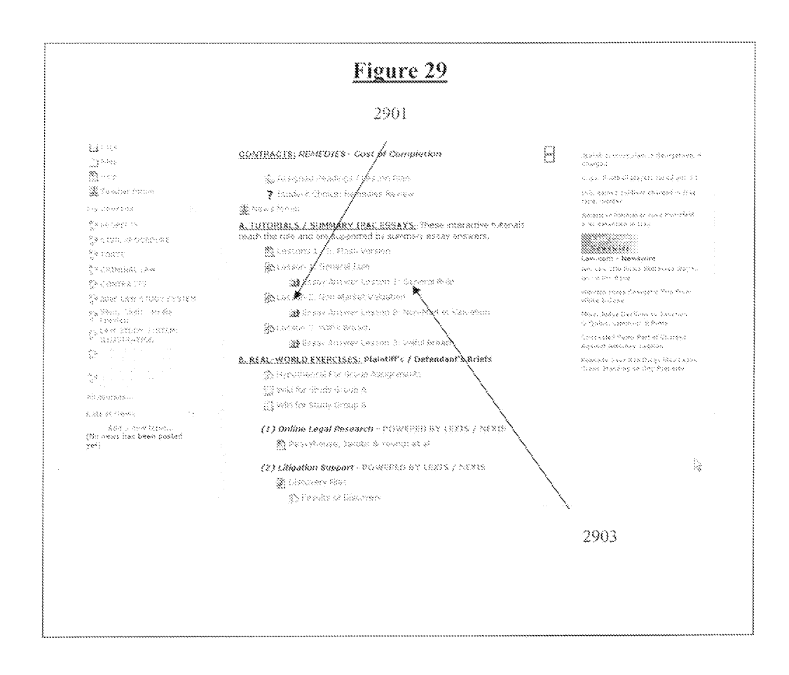

More specifically as shown in FIGS. 29-31 a student can click on her choice of lessons, e.g., ‘Remedies: Cost of Completion: Lesson 1: General Rule’ 2901. This could correspond to a tutorial for the 1L course in Contracts, and to a related test preparation session. Within the Contracts tutorial, the user may wish to sub-select “Essay Answer Lesson 1: General Rule,” 2903 which represents a related piece of content. Still within the range of lessons regarding Remedies, and after having navigated the tutorials for the Cost of Completion/Diminution in Value lesson, the student may wish to take a quiz 3001 to test his understanding of the rule, And for a more rigorous evaluation of his knowledge of the content (and the level of his test-taking skills), the user may wish to proceed to a test prep session 3003 that incorporates the cost of completion rule. To support the use of the system by an individual student or a group of students, the professor may select pre-populated content that targets, e.g., the development of real-world practitioner skills 3005 (Litigation Support) or Study Tips and Common Blunders. The test preparation session, as described and illustrated earlier, commences with Active Reading exercises, which produce a graphic organizer 3101 that is abstracted from an annotated version of the test question. Using the graphic organizer as a roadmap, the user develops the “A” answer 3103, following the IRAC model In the process of developing the “A” answer, the system illustrates a schema of the types of blunders 3105 that commonly cause students to underachieve on their exams.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A computer-readable memory storing computer-executable instructions for providing a computer assisted tutorial, the memory comprising:
computer-executable instructions for providing a hypothetical fact situation, the fact situation including both a first textual explanation and a first graphical image related to said first textual information;
computer-executable instructions for presenting a question based on said hypothetical fact situation;
computer-executable instructions for obtaining a response from a user of a computer, said response indicative of their answer to said question;
computer-executable instructions for providing an indication the correctness of said answer, said indication including both a second textual explanation and a second graphical image related to said second textual information;
computer-executable instructions for asking additional questions, obtaining additional responses, and providing additional indications of correctness; and
computer-executable instructions for providing an essay style indication of outcome to said hypothetical fact situation after all said indications have been provided.

2. The computer-readable memory of claim 1 wherein said first graphical image comprises a still image

3. The computer-readable memory of claim 1 wherein said first graphical image comprises a video image

4. The computer-readable memory of claim 1 wherein said computer assisted tutorial is for a professional school course.

5. The computer-readable memory of claim 4 wherein said computer assisted tutorial is for a law school course.

6. The computer-readable memory of claim 1 further including computer-executable instructions for providing a screen of Frequently Asked Questions (FAQ's)

7. The computer-readable memory of claim 1 wherein said hypothetical fact situation is representative of an essay question on an exam.

8. The computer-readable memory of claim 7 wherein said essay style indication of outcome comprises an excellent answer to said essay question.

9. A computer-readable memory storing computer-executable instructions for providing a computer assisted tutorial, the memory comprising:
computer-executable instructions for providing a hypothetical fact situation, the fact situation including both a first textual explanation and a first graphical image related to said first textual information;
computer-executable instructions for presenting a question based on said hypothetical fact situation;
computer-executable instructions for obtaining a response from a user of a computer, said response indicative of their answer to said question;
computer-executable instructions for providing an indication the correctness of said answer, said indication including both a second textual explanation and a second graphical image related to said second textual information;
computer-executable instructions for asking additional questions, obtaining additional responses, and providing additional indications of correctness; and
computer-executable instructions for providing an indication of the relative accuracy of said answers compared to a plurality of other users providing responses indicative of answers to said questions.

10. The computer readable memory of claim 9 wherein said indication of relative accuracy is provided in graphical form.

11. The computer readable memory of claim 9 wherein said plurality of other users consists of others taking a class which is also being taken by said user.

12. The computer readable memory of claim 9 wherein said plurality of other users comprises all users of said computer-readable memory.

13. The computer-readable memory of claim 1 wherein said computer assisted tutorial is for a professional school course.

14. The computer-readable memory of claim 4 wherein said computer assisted tutorial is for a law school course.

15. A computer-readable memory storing computer-executable instructions for providing a computer assisted test preparation tutorial, the memory comprising:
computer-executable instructions for providing a test question in a graphical display format;
computer-executable instructions for presenting a question based on how to prepare an answer said test question;
computer-executable instructions for obtaining a response from a user of a computer, said response indicative of their answer to said question;
computer-executable instructions for providing an indication the correctness of said answer;
computer-executable instructions for indicating on said graphical display of said test question, indications of annotations related to said correct answer; and
computer-executable instructions for presenting additional questions, obtaining additional responses, providing additional indications, and indicating additional annotations

16. The memory of claim 15 further comprising:
computer-executable instructions for presenting a question based on how to write an essay response to said test question;
computer-executable instructions for obtaining a response from a user of a computer, said response indicative of their answer to said question;
computer-executable instructions for providing an indication the correctness of said answer;
computer-executable instructions for generating a textual indication of a written essay response by placing a correct answer into a textual template; and
computer-executable instructions for presenting additional questions, obtaining additional responses, and adding additional responses to said textual template.

17. The memory of claim 16 further comprising:
computer executable instructions for displaying said textual indication of said written essay response in a format that can be compared to other textual indications of written essay responses which are comparatively less correct.

18. The memory of claim 17 wherein said comparison compares said responses section by section.

19. The memory of claim 17 wherein said comparison compares said responses as a whole.
